(19) United States
(12) Patent Application Publication
(10) Pub. No.: US 2026/0240179 A1
(43) Pub. Date: Aug. 20, 2026

(54) EDIBLE COMPOSITIONS AND METHODS FOR THE PRESERVATION OF FRUITS AND VEGETABLES

(71) Applicant: ONYX LOTUS, LLC, DOVER, DE (US)

(72) Inventor: Varun TAHLAN, DOVER, DE (US)

(21) Appl. No.: 19/161,816

(22) PCT Filed: Mar. 7, 2024
(86) PCT No.: PCT/US2024/018968

§ 371 Date: Sep. 3, 2025

Related U.S. Application Data
(60) Provisional application No. 63/450,620, filed on Mar. 7, 2023.
(60) Provisional application No. 63/450,627, filed on Mar. 7, 2023.
(60) Provisional application No. 63/450,630, filed on Mar. 7, 2023.

(51) Int. Cl. A23B 7/16

(52) U.S. Cl. CPC A23B 7/16

(57) ABSTRACT

The present disclosure provides edible compositions and methods for improving the shelf life and quality of food products, including fruits and vegetables. These edible compositions which contain a plant wax, a metal ion and an essential oil complex are light-stable, non-toxic, non-corrosive, and achieve greater than a 99% kill rate against a variety of pathogens for a period of time greater than 1 day on a variety of food products.

### RELATED APPLICATIONS

This application claims the benefit of U.S. Provisional Application Ser. No. 63/450,620, entitled “Editable Compositions and Methods for the Preservation of Fruits and Vegetables”, filed Mar. 7, 2023, U.S. Provisional Application Ser. No. 63/450,627, entitled “Edible Composition and Methods for the Antispoilage of Fruits and Vegetables”, filed Mar. 7, 2023, and U.S. Provisional Application Ser. No. 63/450,630, entitled “Edible Composition and Methods for the Antispoilage of Fruits and Vegetables”, filed Mar. 7, 2023, which are incorporated herein by reference in their entirety.

### FIELD

Embodiments of the instant disclosure generally relate to edible compositions and methods for improving the shelf life, quality, and rate of spoilage of food products, including fruits and vegetables.

### BACKGROUND

All food, including fruits and vegetables should be safe and free from contamination and spoilage at all points in its journey from its source until it reaches consumers. However, food contamination is a serious public health problem in many countries resulting in foodborne diseases that affect many people year after year.

Food may become contaminated by various microorganisms (microbial spoilage) or by chemical reactions (e.g., oxidation) that result not only in excess waste and loss of money due to products being unfit for consumption, but ingestion of contaminated foods can also cause serious health problems for people who eat it.

Microbial spoilage is cause by microorganisms such as fungi (molds or yeasts) and bacteria. These microorganisms are present everywhere—in the air, soil, and water. Microbes spoil food by growing in food and producing substances that change the color, texture, and odor of the food, eventually making the food unfit for human consumption. Microbial spoilage by molds and yeasts includes souring of milk, growth of mold on bread, and rotting of fruit/vegetables. These microorganisms are rarely harmful to humans, but bacterial contamination is often more dangerous because the food does not always appear to be bad. When microorganisms obtain access to food, they use the nutrients found in the food to rapidly multiply. Microbes can change the food's flavor and synthesize new compounds that can be harmful to humans.

Chemical reactions in food are responsible for changes in the color and flavor of foods during processing and storage. While foods are of best quality when they are fresh, chemical changes can begin automatically within the foods, once harvested or slaughtered, thereby leading to deterioration in quality. For instance, fats break down and become rancid, and naturally occurring enzymes promote major chemical changes in food as food ages. Enzymatic spoilage (or self-destruction) and enzymic browning (i.e., colorless compounds converted into brown-colored compounds when enzymes in food cells are exposed to air) are both chemical decomposition processes involving enzymes.

Historically, chemical preservatives and physical preservation techniques (such as freezing, canning, and pasteurization) have been employed to protect food spoilage caused by microbial or chemical reactions, thereby allowing food manufacturers and grocers to distribute foods around the world without impacting food safety or quality. Chemical preservatives, whether natural (e.g., salt or sugar) or artificial (e.g., benzoates, nitrites, parabens, and sulfites), have been used extensively for many years with food products to ensure safety and avoid quality loss. However, adding excessive amounts of preservatives into food products can cause various ailments in the consumer, such as headaches, heart disease, breathing problems, and cancer. Because of these potential dangers to human life, alternative sources of preservatives are needed.

Plant waxes are the waterproofing components found in an amorphous layer on the outer surface of the plants which act as barrier against environmental stress, such as dehydration. Many plant waxes such as candelilla wax and carnauba wax have been approved by the US Food & Drug Administration (FDA) as a safe food additive. Even though certain plant waxes have obtained this status, they only provide limited protection against bacteria.

Cutin is one of two waxy polymers that are the main components of the plant cuticle, which covers all aerial surfaces of plants, the other waxy polymer is cutan. These waxy polymers are an insoluble substance with waterproof quality. Cutin also harbors cuticular waxes, which assist in cuticle structure. Cutin consists of omega hydroxy acids and their derivatives, which are interlinked via ester bonds, forming a polyester polymer of indeterminate size. Cutin also provides a waxy-water insecticidal substance found in plant cuticles.

The cuticle of a plant is a matrix, mostly comprised of the polyester cutin and a collection of waxes, which covers the aerial surfaces of plant organs. It is a key adaptation for terrestrial life because it forms a waterproof barrier, protecting the plant from desiccation, as well as playing a critical role in plant defense against insects, pathogens, and physical damage.

Waxes such as paraffin wax have been sprayed on fruits and vegetables to add shine, make them more appealing, and provide insecticidal protection on the fruits and vegetables. The paraffin wax also helps extend the shelf life by retaining moisture in fruits and vegetables. But paraffin wax is a petroleum-based wax that is harmful if ingested.

Some fruits, such as apples, produce a natural wax, which can easily be washed away with water and a little gentle rubbing; additional synthetic waxes sometimes augment this natural coating, making it more difficult to remove. A quick soak in vinegar or lemon juice-enhanced water makes it easier to wipe the wax away.

Organic fruit and vegetable producers cannot use petroleum-based wax on their product. These producers may, however, use some forms or derivatives of naturally derived wax or another naturally derived plant wax, such as carnauba, and still be compliant with the organic designation.

Therefore, a need exists for creating non-toxic and non-corrosive edible compositions for more effectively improving the shelf life and quality of food products.

Also needed is an edible composition derived from a naturally derived food product comprising recombinant cutin that preserves a food product (a fruit or a vegetable) for more than 14 days, is light stable, non-toxic, and non-corrosive, and has a neutral pH that does not harm the fruit or the vegetable.

### BRIEF SUMMARY

Embodiments of the present disclosure relate to edible compositions and methods for improving the shelf life and quality of food products, including fruits and vegetables. In one embodiment, the present disclosure provides an edible composition for the preservation of food products comprising at least one metal ion, at least one plant wax, an essential oil and a solvent. In one embodiment, the composition comprises about 0.001 weight % (wt. %) to 2 wt. % of at least one metal ion; about 1.0 wt. % to 10.0 wt. % of a plant wax; about 1 wt. % to 5 wt. % of an essential oil; about 1 wt. % to 5 wt. % of an emulsifying agent; and about 83 wt. % to 98 wt. % of a solvent.

In one embodiment, the present disclosure relates to edible composition for preserving fruits and vegetables with recombinant cutin. In one embodiment, the edible compositions may further comprise a pH stabilizer, at least one metal ion, an essential oil, and emulsifying agent, or combinations thereof.

In one embodiment, the present disclosure provides an edible composition for the preservation of food products comprising at least one metal ion, zein powder, and a solvent. In one embodiment, the edible composition comprises about 0.001 weight % to 2 wt. % of at least one metal ion; about 1.0 wt. % to 10.0 wt. % of a plant wax; about 1 wt. % to 5 wt. % of an essential oil; about 5 wt. % to 20 wt. % of zein powder; and about 88 wt. % to 95 wt. % of a solvent.

In one embodiment, the present disclosure provides methods for preparing an edible composition for preserving a food product comprising, (a) culturing bacteria in a bacterial culture media; (b) transducing the bacterial culture with a plasmid comprising a cutin synthase gene; (c) fermenting the bacterial culture from step (b) to allow for production of genetically modified cutin; and (d) isolating the genetically modified cutin.

In one embodiment, the present disclosure provides methods for making an edible composition for the preservation of food products, the method comprising combining at least one plant wax, at least one emulsifying agent, and at least one acceptable excipient in a solvent to form a plant wax emulsion; and combining the plant wax emulsion with at least one metal ion.

In one embodiment, the present disclosure provides a method for preserving a food product comprising applying an effective amount of an edible composition comprising at least one metal ion, at least one plant wax, at least one emulsifying agent, and a solvent to a food product.

In one embodiment, the present disclosure provides methods for making an edible composition for the preservation of food products, the method comprising combining zein powder with a solvent to form a zein solution and combining at least one metal ion with the zein solution to form the preservative composition.

In one embodiment, the present disclosure provides a method for increasing the shelf life, preserving the quality, and improving the antispoilage properties of a food product comprising applying an effective amount of an edible composition comprising at least one metal ion, zein powder, and a solvent to a food product.

Other features and iterations of the disclosure are described in more detail below.

### BRIEF DESCRIPTION OF THE DRAWINGS

FIG. 1 shows the results of treatment of blueberries over time, with and without zein. Results show the average weight in grams for 5 samples, either treated or untreated.

FIG. 2 shows the results of treatment of blueberries over time, with and without silver nitrate and zein. Results show the average weight in grams for 6 samples, either treated or untreated.

FIG. 3 shows the results of treatment of Java plums over time, with and without zein. Results show the average weight in grams for 8 samples, either treated or untreated.

FIG. 4 shows the results of treatment of blueberries over time, with and without cutin. Results show the average weight in grams for 15 samples, either treated or untreated.

FIG. 5 shows the results of cutin treatment of strawberries over time, with and without cutin. Results show the average weight in grams for 10 samples, either treated or untreated.

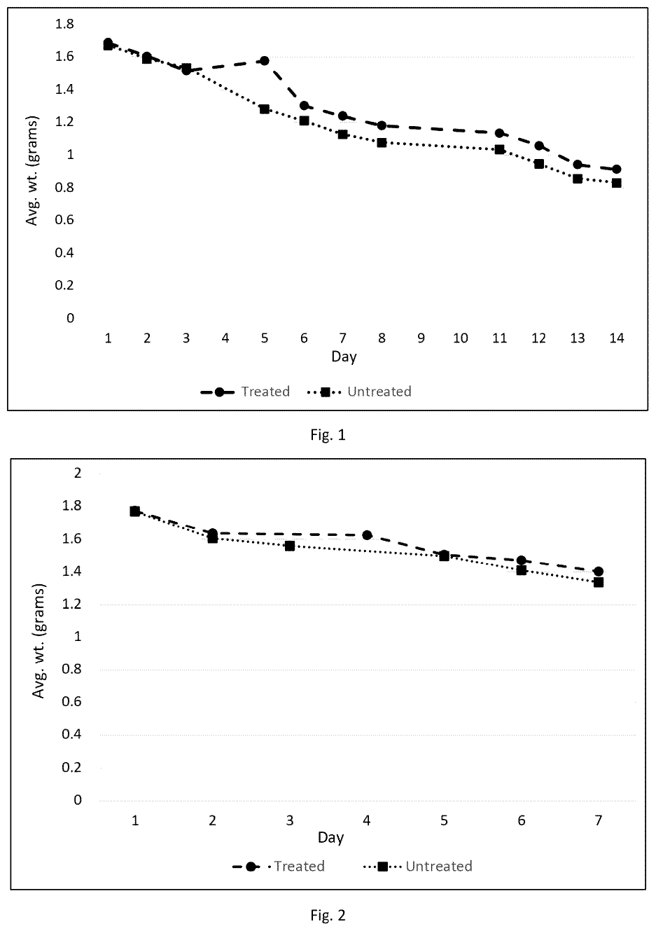

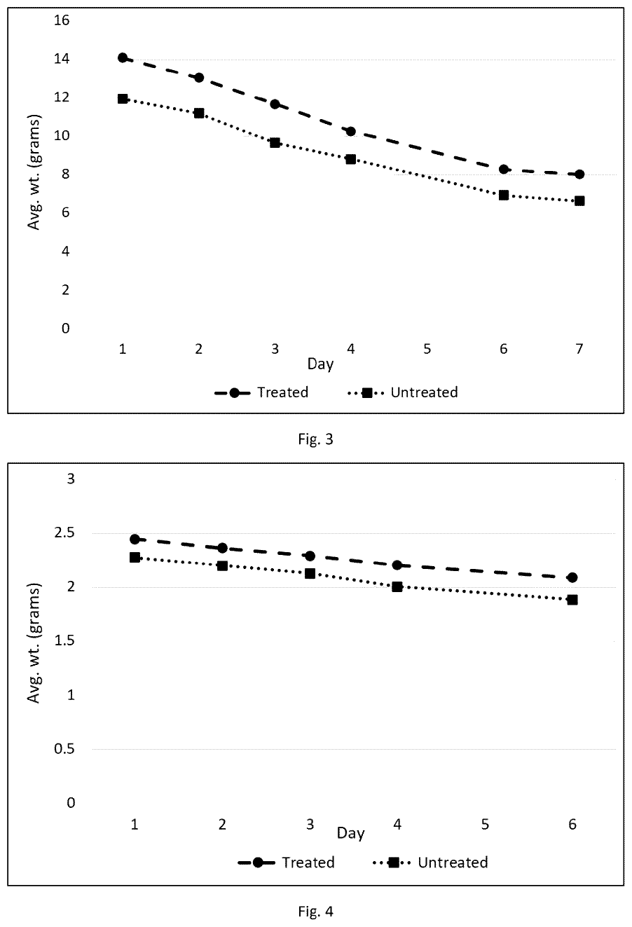

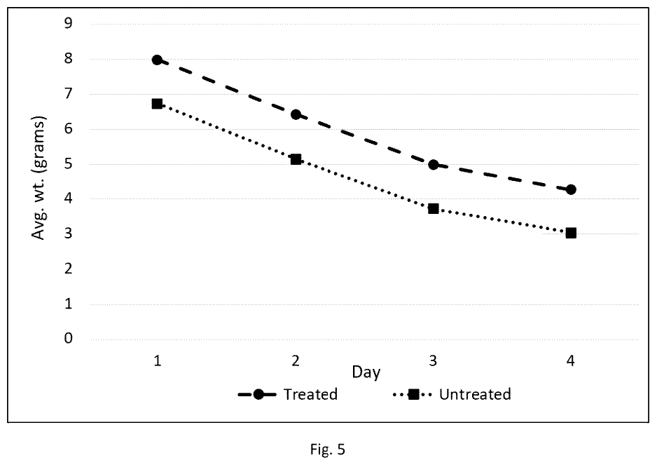

### DEFINITIONS

Unless defined otherwise, all technical and scientific terms used herein have the meaning commonly understood by a person skilled in the art to which this invention belongs.

This description will enable one skilled in the art to make and use the invention, and it describes several embodiments, adaptations, variations, alternatives, and uses of the invention. These and other embodiments, features, and advantages of the present invention will become more apparent to those skilled in the art when taken with reference to the following detailed description of the invention in conjunction with the accompanying drawings.

Reference throughout this specification to “one embodiment”, “some embodiments”, “certain embodiments”, “one or more embodiments”, or “an embodiment” means that a particular feature, structure, material, or characteristic described in connection with the embodiment is included in at least one embodiment of the invention. Thus, the appearances of phrases containing the term “embodiment(s)” in various places throughout this specification are not necessarily referring to the same embodiment of the invention. Furthermore, the particular features, structures, materials, or characteristics may be combined in any suitable manner in one or more embodiments.

In the present disclosure, “%” refers to “weight % (wt. %)” or “mass %”, unless otherwise stated.

As used herein, the phrase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phrase “consisting essentially of” limits the scope of a claim to the specified elements or method steps, plus those that do not materially affect the basis and novel characteristic(s) of the claimed subject matter.

When introducing elements of the embodiments described herein, the articles “a”, “an”, “the” and “said” are intended to mean that there are one or more of the elements.

The terms “comprises”, “comprising”, or any other variations thereof used in the disclosure, are intended to cover a non-exclusive inclusion, such that a device, apparatus, system, assembly, method that comprises a list of components or a series of steps that does not include only those components or steps but may include other components or steps not expressly listed or inherent to such apparatus, or assembly, or device. In other words, one or more elements or steps in a system or device or process proceeded by “comprises . . . a” or “comprising of” does not, without more constraints, preclude the existence of other elements or additional elements or additional steps in the system, device, or process. Besides, the use of “comprising”, “consisting” or “including” also contemplates embodiments that “consist essentially of” or “consist of” the recited formulation and steps of preparation of the formulation.

As used herein, the term “nanoparticle”, in all of its forms, refers to a particle characterized by a particle size of less than one micron.

As used herein, the term “light-stable”, in all of its forms, refers to the disinfectant coating composition not losing efficacy or potency in the presence of light, either sunlight or manmade light.

As used herein, the terms “pathogen” and “microorganism” may be used interchangeably, and refer to bacteria, fungi and viruses.

As used herein, the term “pathogenic sterility” refers to a surface or article that has no viable pathogens present.

As used herein, the terms “antibacterial properties” or “antimicrobial properties” or “disinfectant properties” refers to the ability of a composition to remove greater than 95% of all viable pathogens.

As used herein, the term “kill” refers to the ability of a compositions to act as a biocide.

As used herein, the term “shelf-life” refers to the length of time an item remains usable with antimicrobial properties.

As used herein, the term “antispoilage” refers to the ability of a composition to prevent a food from deteriorating or decomposing due to microbial action.

As used herein, the phrase “does not harm the fruit or the vegetable” refers to the ability of a fruit or vegetable to remain fresh and edible when exposed to the edible compositions described herein.

Concentrations, amounts, and other numerical data are expressed or presented herein in a range format. It is to be understood that such a range format is used merely for convenience and brevity and should be interpreted flexibly to include not only the numerical values explicitly recited as the limits of the range but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range, or the characteristics being described.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity, a numerical range of “about 50 mg/mL to 80 mg/mL” should also be understood to provide support for the range of “50 mg/mL to 80 mg/mL”. The endpoint may also be based on the variability an appropriate regulatory body, such as the FDA, EPA, USP, etc.

In this disclosure, the terms “including”, “containing” and/or “having” are understood to mean “comprising” and are open-ended terms.

As various changes could be made in the above-described methods without departing from the scope of the invention, it is intended that all matter contained in the above description and in the examples given below, shall be interpreted as illustrative and not in a limiting sense.

### DETAILED DESCRIPTION OF EMBODIMENTS

In the following sections, certain exemplary compositions and methods are described to detail certain embodiments of this invention. It will be obvious to one skilled in the art that practicing the certain embodiments does not require the employment of all or even some of the specific details outlined herein, but rather that concentrations, times, and other specific details can be modified through routine experimentation. In some cases, well known methods or components have not been included in the description.

The present disclosure is based on the discovery that the combination of metal ions with plant waxes or zein powder produces an antimicrobial composition that is effective in preserving food products for a period of greater than 14 days. As an antimicrobial and preservative edible composition, 99% of pathogens located on a food product are killed in less than 5 minutes, the freshness of the food product is maintained, and dehydration of the food product is prevented over a period of at least 14 days. Importantly, the edible composition is easily prepared, economical, non-toxic, non-corrosive, and highly stable.

### Section I. Edible Composition for the Preservation of a Food Product

The present invention relates to edible compositions for the preservation of a food product. The edible composition kills a variety of pathogens on a variety of food products and improves the shelf life and quality of the food product. The edible composition is easily prepared, easy to apply, is light stable, heat stable, non-toxic to humans, non-corrosive to the food product, and exhibits antimicrobial properties, antibacterial properties, antifungal properties, or a combination thereof.

Once applied, the edible composition kills more than 99% of pathogens as well as maintains the quality and shelf life of the food product for greater than 14 days.

### At Least One Metal Ion

The edible composition of the present disclosure includes at least one metal ion. The at least one metal ion is considered non-toxic to mammals, either ingested by the mammal, contacted to the skin of the mammal, or contacted to the eye of the mammal. The at least one metal ion is a food safe metal ion and may be derived from a water-soluble metal salt. The water-soluble salt in a solvent releases a metal ion and may be a transition metal salt that imparts disinfectant properties.

Silver, as well as other metal ions, such as copper, zinc, gold, cobalt, zirconium, molybdenum, palladium, and platinum ions possess antimicrobial properties. Salts of these ions are considered to be active antimicrobial agents, antibacterial agents, and antifungal agents as long as a portion of the metal ion dissociates from the metal salt in the solvent (such as water, brine, stomach acid, human serum, blood, or a polar protic solvent).

These metal ions react with pathogens at low ppm (parts per million levels) concentrations in various ways, such as binding to the wall of the pathogen to block substances from coming in or out of the pathogen, releasing active oxygen species which interact with the pathogen's DNA or RNA to inhibit replication of the pathogen, and being transported within the cell of the pathogen to block the respiratory system thereby destroying energy production. By contacting the pathogen with the composition, the metal ion releases reactive oxygen species. Non-limiting examples of reactive oxygen species include but are not limited to oxygen, a superoxide anion, a peroxide anion, a hydroxyl radical, and/or combinations thereof. These reactive oxygen species, once in contact with a pathogen can cause damage to cells through oxidative damage. The metal ions present a positively charged surface, which interact with the negatively charged pathogen membrane and causes physical damage. This membrane permeability can cause disruption by electrostatic interactions with the pathogen.

The metal ion may be derived from a transition metal salt that imparts disinfectant properties and antimicrobial properties. Non-limiting examples of the transition metal salt which impart disinfectant properties are selected from the group consisting of a silver salt, a copper salt, a zinc salt, a gold salt, a cobalt salt, a zirconium salt, a molybdenum salt, a palladium salt, a platinum salt, and combinations thereof.

The anion of the at least one metal salt may have an organic or an inorganic anion. Non-limiting examples of the metal salt include but are not limited to silver nitrate, silver acetate, silver bromide, silver sulfate, silver citrate, silver oxalate, copper (II) acetate, copper (II) sulfate, copper (I) chloride (II) copper and/or zinc carbonate, zinc chloride, zinc nitrate, zinc acetate, zinc sulfate, gold acetate, gold chloride, cobalt (II) sulfate, cobalt (II) chloride, cobalt (II) nitrate, cobalt (II) carbonate, zirconium (IV) nitrate, zirconium (IV) acetate, molybdenum (II) chloride, molybdenum (V) chloride, palladium (II) chloride, and platinum (II) acetate. In one embodiment, the edible composition includes a silver salt, a copper salt, a zinc salt, or combinations thereof. In one embodiment, the edible composition includes a silver salt.

In one embodiment, the edible composition includes a silver salt that is capable of releasing a silver cation, such as Ag+ but potentially Ag²⁺, Ag³⁺ in addition to Ag⁺. Suitable, non-limiting examples of silver salts are silver chloride, silver bromide, silver fluoride (AgF, AgF₂, and/or Ag₂F), silver iodide, silver citrate, silver lactate, silver phosphate, silver carbonate, silver sulfate, silver trifluoroacetate, silver perchlorate, silver acetate, silver nitrate, silver oxide, silver perchlorate, and combinations thereof. In one embodiment, the silver salt is silver nitrate.

The at least one metal salt is present in an amount ranging from about 0.001 wt. % to about 2 wt. % based on the total weight of the long-lasting coating composition. In one embodiment, the at least one metal salt is present in an amount selected from the group consisting of 0.001-2 wt. %, 0.001 to 0.01 wt. %, 0.005-0.01 wt. %, 0.01-0.05 wt. %, 0.03-0.08 wt. %, 0.05-0.1 wt. %, 0.08-0.15 wt. %, 0.1-0.2, 0.15-0.25 wt. %, 0.2-0.3 wt. %, 0.25-0.35 wt. %, 0.3-0.4 wt. %, 0.35-0.45 wt. %, 0.4-0.5 wt. %, 0.45-0.55 wt. %, 0.5-0.6 wt. %, 0.55-0.65 wt. %, 0.6-0.7 wt. %, 0.65-0.75 wt. %, 0.7-0.8 wt. %, 0.75-0.85 wt. %, 0.8-0.9 wt. %, 0.85-0.95 wt. %, 0.9-1.0 wt. %, 0.95-1.1 wt. %, 1.0-1.2 wt. %, 1.1-1.3 wt. %, 1.2-1.4 wt. %, 1.3-1.5 wt. %, 1.4-1.6 wt. %, 1.5-1.7 wt. %, 1.6-1.8 wt. %, 1.7-1.9 wt. % and 1.8-2 wt. %, based on the total weight of the edible composition.

### Plant Wax

The edible composition may further include a plant wax. Plant waxes are waxes that are secreted into and on the surface of plant cuticles to control evaporation, wettability, and hydration. Non-limiting examples of plant waxes include but are not limited to cutin, carnauba wax, soy wax, jojoba wax, candelilla wax, rice bran wax, and/or combinations thereof.

The epicuticular waxes of plants are mixtures of substituted long-chain aliphatic hydrocarbons, containing functional groups such as alkanes, alkyl esters, fatty acids, primary and secondary alcohols, diols, ketones, and aldehydes. With the inclusion of the at least one metal ion, a synergistic effect occurs between the plant wax and the at least one metal ion. Additionally, the plant waxes interact with the at least one metal ion, prevent oxygen from interacting with the at least one metal ion, and prevent moisture from interacting with the at least one metal ion. The plant waxes may have a high propensity to form hydrogen bonds due to the proline amino acid content which interacts with the metal ion through ionic and/or Van der Walls interactions. By interacting with the functional groups, oxygen (O2) and/or water are prevented from interacting with the at least one metal ion. Thus, metal oxides from the at least one metal ions are not formed. This interaction not only stabilizes the complex between the plant waxes and the at least one metal ion but also increases the shelf-life of the edible composition.

In one embodiment, the wt. % of the plant waxes present in the composition can and will vary depending on the at least one metal ion and the plant wax utilized. In one embodiment, the wt. % of the plant wax is from about 1 wt. % to 10 wt. % based on the total weight of the edible composition. In one embodiment, the plant wax is present in an amount selected from the group consisting of 1-10 wt. %, 1-2 wt. %, 1.5-2.5 wt. %, 2.5-3.5 wt. %, 3-4.0 wt. %, 3.5-4.5 wt. %, 4-5 wt. %, 4.5-5.5 wt. %, 5-6 wt. %, 5.5-6.5 wt. %, 7-8 wt. %, 7.5-8.5 wt. %, 8-9 wt. %, 8.5-9.5 wt. %, 9-10 wt. %, 1-3 wt. %, 3-5 wt. %, 5-7 wt. %, 7-9 wt. %, 2-4 wt. %, 4-6 wt. %, 6-8 wt. % and 8-10 wt. %, based on the total weight of the edible composition.

In one embodiment, the edible composition may include a recombinant form of cutin. Recombinant, defined herein, are products produced by recombinant organisms, recombinant proteins/enzymes or encoded by recombinant DNA, etc. The term “recombinant” relates to or is derived from a nucleic acid or genetic material that has been manipulated in vitro. In one embodiment, the recombinant cutin comprises cutin expressed from DNA of a bacteria. The bacteria comprise a plasmid containing a cutin synthase gene. A variety of bacteria may be used to produce recombinant cutin. Non-limiting examples of suitable bacteria include but are not limited to Escherichia coli, Bacillus subtilis, Pseudomonas putida, Streptomyces, Corynebacterium glutamicum, and Agrobacterium tumefaciens. In one embodiment, yeast cells are used to produce recombinant cutin. Non-limiting examples of yeast strains used for transformation include Saccharomyces cerevisiae, Pichia pastoris, Kluyveromyces lactis, Hansenula polymorpha (also known as Pichia angusta), Yarrowia lipolytica, Schizosaccharomyces pombe, Candida utilis, Debaryomyces hansenii, Ogataea polymorpha (formerly Hansenula polymorpha), Cryptococcus neoformans and Candida boidinii.

The edible composition may include zein powder. Zein powder is a class of prolamine protein found in maize (corn) having a high proline amino acid content and water soluble. The zein powder may be from a natural source of zein powder, a synthetic source of zein powder, a derivative of zein powder, and/or combinations thereof. Zein powder has antimicrobial properties and preservative properties. With the inclusion of the at least one metal ion, a synergistic effect occurs between the zein powder and the at least one metal ion. In one embodiment, the zein powder interacts with the at least one metal ion, prevents oxygen from interacting with the at least one metal ion, and prevents moisture from interacting with the at least one metal ion. The zein powder has a high propensity to form hydrogen bonds due to the proline amino acid content which interacts with the metal ion through ionic and/or Van der Walls interactions. By interacting with the proline amino acids, oxygen (O₂) and/or water are prevented from interacting with the at least one metal ion. Thus, metal oxides from the at least one metal ions are not formed. This interaction not only stabilizes the complex between the zein powder and the at least one metal ion but also increases the shelf-life of the edible composition.

The wt. % of the zein can and will vary depending on the at least one metal ion and the food product that the edible composition is to be used on. The wt. % of the zein powder is about 5 wt. % to about 20 wt. %, based on the total weight of the edible composition. In one embodiment, the zein powder is present in an amount selected from the group consisting of 5-20 wt. %, 5-6 wt. %, 7-8 wt. %, 9-10 wt. %, 11-12 wt. %, 13-14 wt. %, 15-16 wt. %, 17-18 wt. %, 19-20 wt. %, 1-3 wt. %, 3-5 wt. %, 5-7 wt. %, 7-9 wt. %, 9-11, 11-13 wt. %, 13-15 wt. %, 15-17 wt. %, 17-19 wt. %, 19-20 wt. %, 2-8 wt. %, 8-14 wt. %, and 14-20 wt. %, based on the total weight of the composition.

### Emulsifying Agents

The edible composition may further include an emulsifying agent which is non-toxic to mammals. The emulsifying agent provides greater solubility of at least one metal ion and the plant wax, aids in stabilization the at least one metal ion, and provides a synergistic effect between the plant wax and the at least one metal ion. Non-limiting examples of suitable emulsifying agents may comprise lecithin, a monoglyceride, a diglyceride, a polysorbate, a carrageenan, a polyglycerol of a fatty acid, a sorbitol ester, a beeswax, or combinations thereof. In one embodiment, the emulsifying agent comprises polysorbate 80, sodium stearoyl lactylate, propylene glycol, Tween 80®, and sodium caseinate. The emulsifying agent is non-toxic to humans and other mammals.

In one embodiment, the wt. % of the emulsifying agent present in the composition is about 1 wt. % to 5 wt. %, based on the total weight of the edible composition. In one embodiment, the emulsifying agent is present in an amount selected from the group consisting of 1-5 wt. %, 1-1.5 wt. %, 1.5-2 wt. %, 2-2.5 wt. %, 2-3 wt. %, 2.5-3.5 wt. %, 3-4 wt. %, 3.5-4.5 wt. %, 4-5 wt. %, 2 wt. %, 1-3 wt. %, 3-5 wt. %, and 2-4 wt. %, based on the total weight of the edible composition.

### Solvent

In one embodiment, the composition further includes a solvent. In one embodiment, the solvent is a solvent that is compatible with the human skin or taken internally within the human subject.

In one embodiment, the solvent comprises a polar protic, a polar aprotic, a non-polar protic solvent, or a combination thereof. The solvent can and will vary depending on the components used in the disinfectant emulsion composition containing an essential oil complex. In one embodiment, the solvent is a polar protic solvent, a polar aprotic solvent, or combinations thereof. Suitable examples of polar protic solvents include, but are not limited to, water; alcohols such as methanol, ethanol, isopropanol, n-propanol, iso-butanol, n-butanol, s-butanol, t-butanol, and the like; diols such as ethylene glycol, propylene glycol; polyols such as glycerol, mannitol, sorbitol; and combinations thereof. Non-limiting examples of suitable polar aprotic solvents include but are not limited to acetonitrile N,N-dimethylacetamide (DMAC), N,N-dimethylformamide (DMF), dimethyl sulfoxide (DMSO), 1,4-dioxane, N-methyl-2-pyrrolidinone (NMP), hexamethylphosphoramide, N-methylacetamide, tetrahydrofuran (THF), 2-methyltetrahydrofuran, and combinations thereof. The polar protic solvent, the polar aprotic solvent, or a combination of the polar protic and polar aprotic solvent are utilized with water, bine, or a buffer in the composition. In one embodiment, the at least one solvent comprises water and a buffer. The solvent is non-toxic to humans and other mammals.

In one embodiment, the solvent is present in the composition in an amount from about 83 wt. % to 98 wt. % based on the total weight of the edible composition. In one embodiment, the solvent is present in the composition in an amount selected from the group consisting of 83-98 wt. %, 83-84 wt. %, 83.5-84.5 wt. %, 85-86 wt. %, 85.5-86.5 wt. %, 86-87 wt. %, 86.5-87.5 wt. %, 87-77 wt. %, 87.5-88.5 wt. %, 88-89 wt. %, 88.5-89.5 wt. %, 88-90 wt. %, 89.5-90.5 wt. %, 90-91 wt. %, 90.5-91.5 wt. %, 91-92 wt. %, 91.5-92.5 wt. %, 92-93 wt. %, 92.5-93.5 wt. %, 93-94 wt. %, 93.5-94.5 wt. %, 94-95 wt. %, 94.5-95.5 wt. %, 95-96 wt. %, 95.5-96.5 wt. %, 96-97 wt. %, 96.5-97.5 wt. %, 97-98 wt. %, 83-86 wt. %, 86-92 wt. %, and 92-98 wt. %, based on the total weight of the edible composition.

### Acceptable Excipient

In one embodiment, the edible composition may additionally include an acceptable excipient. The edible composition remains effective when the acceptable excipient is not included in the composition. With the inclusion of the acceptable excipient, the properties of the edible composition are enhanced, such as an elongated shelf-life. Non-limiting examples of the acceptable excipient include but are not limited to a preservative (e.g., potassium sorbate, sorbic acid), a stabilizer, and/or combinations thereof. Non-limiting examples of stabilizers include but are not limited to xanthan gum, carrageenan, guar gum, agar, locust bean gum (carob gum) cellulose gum (carboxymethyl cellulose), pectin, gum arabic, sodium alginate, gelatin, and/or combinations thereof.

In one embodiment, the wt. % of the stabilizer is present in an amount ranging from 1-5 wt. %, based on the total weight of the food contact safe composition containing an essential oil complex. In one embodiment, the wt. % of the stabilizer is present in an amount selected from the group consisting of 1-5 wt. %, 1-1.5 wt. %, 1.5-2.0 wt. %, 2-2.5 wt. %, 2.5-3 wt. %, 3-3.5 wt. %, 3.5-4 wt. %, 4-4.5 wt. %, 4.5-5 wt. %, 1-3 wt. %, 3-5 wt. % and 2-4 wt. %, based on the total weight of the food contact safe composition containing an essential oil complex.

In one embodiment, the acceptable excipient is present in an amount ranging from about 0.1 wt. % to 1.0 wt. %, based on the total weight of the edible composition. In one embodiment, the excipient is present in an amount selected from the group consisting of 0.1-1 wt. %, 0.1-0.2 wt. %, 0.3-0.4 wt. %, 0.5 wt.-0.6 wt. %, 0.7-0.8 wt. %, 0.9-1 wt. %, 0.1-0.3 wt. %, 0.3-0.5 wt. %, 0.5-0.7 wt. %, 0.7-0.9 wt. %, and 0.9-1. wt. %, based on the total weight of the edible composition.

### pH Stabilizer

In one embodiment, the edible composition may further include a pH stabilizer. The pH stabilizer adjusts the pH to a more neutral pH. In one embodiment, the pH stabilizer may be a proton acceptor. In one embodiment, the proton acceptor may be an inorganic proton acceptor. In one embodiment, the proton acceptor may be a solid, a concentrated aqueous solution, or a dilute aqueous solution. In one embodiment, numerous proton acceptors are used in adjusting the pH of the slurry of the preservation composition. The proton acceptor may be inorganic in nature. Non-limiting examples of suitable inorganic proton acceptors include but are not limited to sodium hydroxide, potassium hydroxide, calcium hydroxide, barium hydroxide, ammonia, cesium carbonate, sodium bicarbonate, potassium bicarbonate, sodium carbonate, potassium carbonate, calcium carbonate, sodium borate, sodium dihydrogen phosphate, disodium hydrogen phosphate, sodium methoxide, sodium tert-butoxide, potassium tert-butoxide, sodium acetate, potassium acetate and/or combinations thereof. The amount of the proton acceptor used depends on the initial pH of the composition.

### Essential Oil

In one embodiment, the edible composition may further include an essential oil. In one embodiment, the essential oil is added to the edible composition and has a synergistic effect with the cutin and/or the at least one metal ion. In one embodiment, the essential oil is considered food safe when ingested, applied, or absorbed by a mammalian subject without causing an allergic or other severe reaction. Various essential oils possess antimicrobial properties. In one embodiment, with the inclusion of the at least one metal ion, a synergistic effect occurs between the essential oil and the at least one metal ion and cutin. Additionally, the essential oil and the recombinant cutin interacts with the at least one metal ion, prevents oxygen from interacting with the at least one metal ion, and prevents moisture from interacting with the at least one metal ion. The essential oil may have a high propensity to form hydrogen bonds, and has various ionic functional groups such alkenes, aromatics, ketones, carboxylates, hydroxyl groups, amine groups, sulfide groups, heterocyclic groups, or combinations thereof which interacts with the metal ion through ionic and/or Van der Walls interactions. By interacting with the ionic functional groups, oxygen (O2) and/or water are prevented from interacting with the at least one metal ion. Thus, metal oxides from the at least one metal ions are not formed. This interaction not only stabilizes the complex but also increases the shelf-life of the composition.

In one embodiment, a wide variety of essential oils are used in the edible composition. In one embodiment, the essential oil is a natural essential oil, a synthetic essential oil, or a derivative of an essential oil. In one embodiment, the essential oil is further purified by means known in the art. Non-limiting examples of suitable essential oils include tea tree oil, thyme oil, eucalyptus oil, oregano oil, peppermint oil, rosemary oil, clove oil, cinnamon oil, lemongrass oil, and/or combinations thereof.

In one embodiment, the wt. % of the essential oil can and will vary depending on the essential oil used in the composition, the at least one metal ion, the intended use of the composition, and the emulsifying agent. In one embodiment, the wt. % of the essential oil is present in an amount ranging from 1-5 wt. %, based on the total weight of the food contact safe composition containing an essential oil complex. In one embodiment, the wt. % of the essential oil is present in an amount selected from the group consisting of 1-5 wt. %, 1-1.5 wt. %, 1.5-2.0 wt. %, 2-2.5 wt. %, 2.5-3 wt. %, 3-3.5 wt. %, 3.5-4 wt. %, 4-4.5 wt. %, 4.5-5 wt. %, 1-3 wt. %, 3-5 wt. % and 2-4 wt. %, based on the total weight of the food contact safe composition containing an essential oil complex.

In one embodiment, the present disclosure provides a method for disinfecting and/or maintaining the pathogenic sterility of an article comprising contacting the article with the food contact safe composition containing an essential oil complex. In one embodiment, the food contact safe composition is applied at 0.1-1000 μL/cm² to 1-10 mL/cm².

In one embodiment, the food contact safe composition is applied at a concentration of 0.1-1000 μL/cm² to 1-10 mL/cm². In one embodiment, the food contact safe composition is applied at a concentration selected from the group consisting of 0.01-1000 μL/cm², 0.05-1000 μL/cm², 0.1-1000 μL/cm², 0.5-1000 μL/cm², 1 mL/cm², 1.5 mL/cm², 0.5-1.5 mL/cm², 1-2 mL/cm², 1.5-2.5 mL/cm², 2-3 mL/cm², 2.5-3.5 mL/cm², 3-4 mL/cm², 3.5-4.5 mL/cm², 4-5 mL/cm², 4.5-5.5 mL/cm², 5-6 mL/cm², 5.5-6.5 mL/cm², 6-7 mL/cm², 6.5-7.5 mL/cm², 7-8 mL/cm², 7.5-8.5 mL/cm², 8-9 mL/cm², and 9.5-10 mL/cm², or combinations thereof.

### Properties of the Edible Composition

The edible composition as disclosed herein has distinctive properties.

The edible composition has a pH ranging from 6.0 to 8.0, using the pH stabilizer. In one embodiment, the range of pH is selected from the group consisting of 6.0-6.5, 6.3-6.8, 6.5-7.5, 6.8-7.8 and 7.5-8.0. By having a neutral pH, the edible composition is considered non-corrosive and non-toxic, can be applied to a variety of food products, can contact human skin, or can be safely ingested by a human or other mammal.

The edible composition is heat stable and light-stable. Heat stability allows the edible composition to be applied to food products above room temperature and maintains the preservative and disinfectant properties for a period of time greater than 14 days.

In one embodiment, the edible composition does not contain nanoparticles.

The edible composition may contact a surface on a variety of food products, and maintain contact for a period greater than 14 days. As such, the edible composition would remain effective for a period greater than 14 days. The freshness of the food product is characterized by the hydration level of the food product and an absence of a soft interior, a wrinkled skin, a discoloration of the food product, or bruising of the food product. In one embodiment, the edible composition remains effective in preserving and maintaining the freshness of the food product for a period greater than 14 days, greater than 20 days, greater than 25 days, or even greater than 30 days.

In one embodiment, the edible composition maintains its effectiveness for a period of time selected from the group consisting of 12 hours to 6 months; one week to one month; one month to 6 months; three months to 6 months; one day to one month; 5-20 days; 1-10 days; 1-180 days; 15-180 days and 12-24 hours or combinations thereof.

The edible composition exhibits antimicrobial properties, antibacterial properties, antifungal properties, or a combination thereof against a variety of pathogens on the surface of the food products such listeria and botulism as verified by the following tests: for bacteria and fungi: AOAC Use Dilution Method (UDM), ASTM E 2315, ISO 22196:2011. Other test systems used for this method include three strains of Listeria monocytogenes (ATCC 49594, 19114, 19116), three strains of Escherichia coli serotype O157:H7 (ATCC 43895, 35150, 43890), and three strains of Salmonella choleraesuis subsp. choleraesuis (serotype javiana ATCC 10721, serotype newport ATCC 6962, serotype typhirmirium ATCC 13311). The pathogen kill rate is greater than 99% after less than a 5-minute period of time and preservative and pathogenic sterility is maintained for greater than 14 days.

### Section II. Method of Preparing the Edible Composition

In another aspect, the present disclosure provides methods for preparing the edible compositions. Method I comprises combining a plant wax, an emulsifying agent, and optionally at least one acceptable excipient, in a solvent to form a plant wax emulsion; and combining the plant wax emulsion with at least one metal ion to form the edible composition.

In yet another aspect, Method II of the present disclosure provides methods of preparing the edible composition comprising combining zein powder in a solvent to form a zein solution, and combining at least one metal ion with the zein solution to form the edible composition.

In yet another aspect, Method III of the present disclosure provides methods isolating the cutin synthase gene (CYP86A2) from genomic DNA of Arabidopsis thaliana, using PCR amplification.

The methods, as disclosed herein, may be conducted in a batch process, a semi-batch process, a semi-continuous process, or a continuous process. The methods may be conducted in the dark and/or under an inert atmosphere and are not necessarily required to prepare the edible composition.

### Method I

### Step (a): Combining a Plant Wax, an Emulsifying Agent, and an Optional at Least One Acceptable Excipient in a Solvent to Form a Plant Wax Emulsion

The first step in Method I disclosed herein, comprises combining a plant wax, an emulsifying agent, and optionally at least one acceptable excipient, in a solvent to form a plant wax emulsion. The plant wax, the emulsifying agent, the optional acceptable excipient, and the solvent are described in more detail above in Section I.

Step (a) may be conducted under an inert atmosphere. Suitable inert gases include but are not limited to helium, nitrogen, argon and/or combinations thereof.

In step (a), the plant wax, the emulsifying agent, the optional at least one acceptable excipient, and the solvent may be added portion wise, in any sequential order, or entirely to the solvent with stirring to form a solution. Suitable methods are known in the art for stirring mixtures, such as magnetic stirring, mechanical stirring, jet mixers, etc.

In one embodiment, the temperature of mixing in step (a) ranges from about 40° C. to 100° C. In one embodiment, the temperature of mixing in step (a) is selected from the group consisting of 40-100° C., 50-90° C., and 70-80° C.

In one embodiment, the duration of mixing in step (a) ranges from about 1 minute to 30 minutes until a homogeneous mixture is obtained by visual determination. In one embodiment, the duration of mixing is selected from the group consisting of 1-30 minutes, 2-15 minutes, and 3-10 minutes, until a homogeneous solution is obtained as visually determined.

Step (b): Combining the Plant Emulsion with at Least One Metal Ion

The next step in method I comprises combining the mixture from step (a) with at least one metal ion. Metal ions are described in more detail above in Section I.

Step (b) may be conducted under an inert atmosphere. Suitable inert gases include but are not limited to helium, nitrogen, argon and/or combinations thereof.

In step (b), the at least one metal ion may be added slowly, portion wise, or entirely to the emulsion from step (a) with stirring. Suitable methods are known in the art for stirring mixtures, such as magnetic stirring, mechanical stirring, jet mixers, etc.

In one embodiment, the temperature of mixing in step (b) ranges from about 40° C. to 100° C. In one embodiment, the temperature of mixing in step (b) is selected from the group consisting of 40-100° C., 50-90° C., and 70-80° C.

In one embodiment, the duration of mixing in step (b) ranges from 1 minute to 30 minutes until a heterogeneous mixture is obtained by visual determination. In one embodiment, the duration of mixing is selected from the group consisting of 1-30 minutes, 2-15 minutes, and 3-10 minutes, until a homogeneous solution is obtained as visually determined.

In one embodiment, after the solution is cooled to room temperature, the pH of the edible composition is adjusted to a pH of 6.0 to 7.0. In one embodiment, the composition is combined with an aqueous solution of a proton acceptor or a solid proton acceptor. The proton acceptor may be a solid, a concentrated aqueous solution, or a dilute aqueous solution. Numerous proton acceptors are used in adjusting the pH of the slurry of the composition. The proton acceptor may be inorganic in nature. Non-limiting examples of suitable inorganic proton acceptors include but are not limited to sodium hydroxide, potassium hydroxide, calcium hydroxide, barium hydroxide, ammonia, cesium carbonate, sodium bicarbonate, potassium bicarbonate, sodium carbonate, potassium carbonate, calcium carbonate, sodium borate, sodium dihydrogen phosphate, disodium hydrogen phosphate, sodium methoxide, sodium tert-butoxide, potassium tert-butoxide, sodium acetate, potassium acetate and/or combinations thereof. The amount of the proton acceptor used depends on the initial pH of the composition.

In one embodiment, after the pH is adjusted, the edible composition is formed.

### Method II

### Step (a): Combining Zein Powder in a Solvent to Form a Zein Solution

The first step in Method II comprises combining zein powder with a solvent to form a zein solution. Zein powder and the solvent are described in more detail above in Section I.

Step (a) may be conducted under an inert atmosphere. Non-limiting examples of suitable inert gases include but are not limited to helium, nitrogen, argon, and/or combinations thereof.

In step (a), zein powder and the solvent may be added portion-wise, in any sequential order, or entirely to the solvent with stirring to form a solution. Suitable methods are known in the art for stirring mixtures, such as magnetic stirring, mechanical stirring, jet mixers, and the like.

In one embodiment, the temperature of mixing in step (a) ranges from about 0° C. to 50° C. In one embodiment, the temperature of mixing in step (a) is selected from the group consisting of 0-50° C., 10-40° C., and 20-30° C. In one embodiment, the temperature of mixing in step (a) 23° C.

In one embodiment, the duration of mixing ranges from 1 minute to 30 minutes until a homogeneous mixture is obtained by visual determination. In one embodiment, the duration of mixing is selected from the group consisting of 1-30 minutes, 2-15 minutes, and 3-10 minutes, until a homogeneous solution is obtained as visually determined.

Step (b): Contacting the at Least One Metal Ion with the Zein Solution

The next step in Method II comprises combining the solution from step (a) with at least one metal ion. Metal ions are described in more detail above in Section I.

Step (b) may be conducted under an inert atmosphere. Non-limiting examples of suitable inert gases include but are not limited to helium, nitrogen, argon, and/or combinations thereof.

In step (b), the at least one metal ion is added slowly, portion wise, or entirely to the solution from step (b) with stirring. Suitable methods are known in the art for stirring mixtures, such as magnetic stirring, mechanical stirring, jet mixers, etc.

The temperature of mixing in step (b) ranges from 0° C. to 50° C. In one embodiment, the temperature of mixing in step (b) is selected from the group consisting of 0-50° C., 10-40° C., and 20-30° C. In one embodiment, the temperature of mixing in step (b) 23° C.

In one embodiment, the duration of mixing ranges from 1 minute to 30 minutes until a homogeneous mixture is obtained by visual determination. In one embodiment, the duration of mixing is selected from the group consisting of 1-30 minutes, 2-15 minutes, and 3-10 minutes, until a homogeneous solution is obtained as visually determined.

### Method III

The first step in Method III comprises isolating the cutin synthase gene (CYP86A2) from genomic DNA of Arabidopsis thaliana, using PCR amplification.

In one embodiment, the next step involves inserting the CYP86A2 gene into an appropriate yeast expression vector. Non-limiting suitable vectors include pYES2/CT, which contains the inducible yeast promoter GAL1, as well as an ampicillin resistance gene for selection in bacteria.

In one embodiment, the CYP86A2 gene is then inserted and ligated into the multiple cloning site of the pYES2/CT vector, prior to transforming Saccharomyces cerevisiae BY4741 cells with the recombinant pYES2/CT vector using the lithium acetate method. Other suitable yeast expression vectors can be used depending on the selected yeast strain.

Yeast cells containing the pYES2/CT-CYP86A2 recombinant gene are selected on YPD agar plates containing ampicillin to identify colonies that have successfully taken up the vector. Other suitable selection methods can be used depending on the selected yeast strain.

Real time reverse transcription polymerase chain reaction (RT-PCR) is performed on transformed yeast cells grown with galactose under inducing conditions, to detect mRNA expression of the CYP86A2 gene.

The native GAL1 yeast promoter may be replaced with a stronger yeast promotor such as PGK1 to enhance expression levels of the CYP86A2 gene. Other suitable yeast promoters can be used depending on the selected yeast vector.

Gas chromatography-mass spectrometry (GC-MS) can be used to analyze the production of cutin in the transformed Saccharomyces cerevisiae BY4741 cells, or other transformed yeast cells.

Saccharomyces cerevisiae BY4741 cells, or other yeast cells expressing cutin, are inoculated into a bioreactor and cutin synthesis is induced. As described herein, a bioreactor is a device or system used in biotechnology to support and control the growth of biological organisms or biochemical processes. It provides a controlled environment, typically including controlled temperature, pH, oxygen levels, and nutrient supply, to optimize the growth and productivity of cells, tissues, or microorganisms for various applications such as fermentation, cell culture, or bioconversion. Bioreactors are commonly used in industries such as pharmaceuticals, biotechnology, food and beverage, and wastewater treatment for production of bio-based products, research, and development purposes.

Recombinant cutin is harvested by cell disruption and purified. Purification consists of the following steps:

Step 1—Initial Fractionation: The crude extract obtained from the fermentation broth is initially fractionated using solvent extraction. For example, the crude extract can be mixed with a solvent such as hexane, which selectively extracts non-polar compounds like lipids and cutin. After mixing and separation, the hexane layer containing the lipids and cutin is separated from the aqueous layer containing other cellular components.

Step 2—Chromatographic Separation: Flash chromatography can be employed for further purification of cutin. In this method, the crude extract dissolved in a suitable solvent is loaded onto a flash chromatography column packed with a stationary phase (e.g., silica gel). As the solvent is pumped through the column, compounds in the crude extract separate based on their interaction with the stationary phase and elute at different times. Cutin, being less polar, tends to elute later than more polar compounds, allowing for its isolation.

Step-3 Gradient Elution: In flash chromatography, gradient elution can be used to improve the separation of cutin from other compounds. A gradient of solvents with increasing polarity (e.g., from hexane to ethyl acetate) is applied during the chromatographic run. This gradient gradually increases the polarity of the mobile phase, selectively eluting the less polar cutin later in the chromatogram, while more polar compounds elute earlier. By adjusting the gradient slope and composition, the separation and purification of cutin can be optimized.

### III. Methods of Preparing and Disinfecting a Surface of a Food Product

In another aspect, the present disclosure provides methods of preserving and disinfecting a food product comprising contacting the food product with the edible composition. The method comprises contacting the surface of the food product with an effective amount of the edible composition.

### The Edible Composition

The edible composition is described in more detail above in Section I.

### Food Products

The edible composition prepared as described in Section II above, may be applied to the outer surface of a food product. Following application of the edible composition to the surface of a food product, the surfaces of the food product are preserved and disinfected and also provided with antispoilage properties.

The food product may be a fruit. Non-limiting examples of fruits may include apple and crabapple (Malus), chokeberry (Aronia), hawthorn (Crataegus and Rhaphiolepis), loquat (Eryobotrya japonica), medlar (Mespilus germanica), pear, European and Asian species (Pyrus), quince (Cydonia oblonga and Chaenomeles), rose hip, Rowan (Sorbus), service tree (Sorbus domestica), serviceberry or saskatoon (Amelanchier), shipova (Sorbopyrus auricularis), apricot (Prunus armeniaca or Armeniaca vulgaris); sweet, black, sour, and wild cherry species (Prunus avium, Prunus serotina, P. cerasus, and others), chokecherry (Prunus virginiana), greengage, a cultivar of the plum, hybrids of the preceding species, such as the pluot, aprium and peacotum, peach (of the normal and white variety) and its variant the nectarine (Prunus persica), plum, of which there are several domestic and wild species, blackberry, of which there are many species and hybrids, such as dewberry, boysenberry, olallieberry, tayberry and loganberry (genus Rubus), cloudberry (Rubus chamaemorus), loganberry (Rubus loganobaccus), raspberry, several species (genus Rubus), salmonberry (Rubus spectabilis), thimbleberry (Rubus parviflorus), wineberry (Rubus phoenicolasius), bearberry (Arctostaphylos spp.), bilberry or whortleberry (Vaccinium spp.), blueberry (Vaccinium spp.), crowberry (Empetrum spp.), cranberry (Vaccinium spp.), huckleberry (Vaccinium spp.), lingonberry (Vaccinium vitis-idaea), strawberry tree (Arbutus unedo), agai (Euterpe), barberry (Berberis; Berberidaceae), currant (Ribes spp.; Grossulariaceae), red, black, and white types, elderberry (Sambucus; Caprifoliaceae), gooseberry (Ribes spp.; Grossulariaceae), hackberry (Celtis spp.; Cannabaceae), honeysuckle, (Lonicera spp.; Caprifoliaceae), mulberry (Morus spp.; Moraceae), mayapple (Podophyllum spp.; Berberidaceae), nannyberry or sheepberry (Viburnum spp.; Caprifoliaceae), Oregon grape (Mahonia aquifolium; Berberidaceae), sea-buckthom (Hippophae rhamnoides; Elaeagnaceae), sea grape (Coccoloba uvifera; Polygonaceae), wolfberry (Lycium barbarum, Lycium spp.; Solanaceae), arhat (Siraitia grosvenorii; Cucurbitaceae), che (Cudrania tricuspidata; Moraceae), Chinese Mulberry, cudrang, Mandarin Melon Berry, Silkworm Thorn, zhe, goumi (Elaeagnus multiflora ovata; Elaeagnaceae), hardy kiwi (Actinidia arguta), kiwifruit or Chinese gooseberry (Actinidia spp.; Actinidiaceae), lapsi (Choerospondias axillaris Roxb.), nungu, persimmon (aka Sharon Fruit, Diospyros kaki; Ebenaceae), rhubarb (Rheum rhaponticum; Polygonaceae), sageretia (Sageretia theezans; Rhamnaceae) also called mock buckthorn, American grape: North American species (e.g., Vitis labrusca; Vitaceae) and American-European hybrids, grape (Vitis vinifera), American Mayapple (Podophyllum peltatum; Berberidaceae), American persimmon (Diospyros virginiana; Ebenaceae), beach plum (Prunus maritima), blueberry (Vaccinium, sect. Cyanococcus; Ericaceae), buffaloberry (Shepherdia argenta; Elaeagnaceae), chokecherry (Prunus virginiana), cocoplum (Chrysobalanus icaco; Chrysobalanaceae), cranberry (Vaccinium oxycoccus), false-mastic (Mastichodendron foetidissimum; Sapotaceae), ground plum (Astragalus caryocarpus; Fabaceae), also called ground-plum milk-vetch, pawpaw (Asimina triloba; Annonaceae), persimmon (Diospyros virginiana; Ebenaceae), pigeon plum (Coccoloba diversifolia; Polygonaceae), salal berry (Gaultheria shallon; Ericaceae), salmonberry (Rubus spectabilis; Rosaceae), saw palmetto (Serenoa repens; Ericaceae), Texas persimmon (Diospyros texana; Ebenaceae), thimbleberry (Rubus parviflorus; Rosaceae), toyon (Heteromeles arbutifolia; Rosaceae), cardón (Pachycereus pringlei; Cactaceae), dragonfruit (Hylocereus undatus; Cactaceae), also called pitaya, prickly pear (Opuntia spp.; Cactaceae), saguaro (Carnegiea gigantea; Cactaceae), kahikatea (Dacrycarpus dacrydioides), manoao (Manoao colensoi), nageia (Nageia spp.), podocarpus (Podocarpus spp.), prumnopitys (Prumnopitys spp.), rimu (Dacrydium cupressinum), butternut squash (Cucurbita moschata), cushaw squash (Cucurbita mixta), Hubbard squash, buttercup squash (Cucurbita maxima), pumpkin, acorn squash, zucchini, summer squash (Cucurbita pepovarieties), horned melon (Cucumis metuliferus), melon (Cucumis melo): cantaloupe, galia, and other muskmelons, honeydew, raisin tree (Hovenia dulcis, Rhamnaceae) also called Japanese Raisin Tree, strawberry (Fragaria spp.; Rosaceae), black mulberry (Morus nigra; Moraceae), cornelian cherry (Cornus mas; Cornaceae), date palm (Phoenix dactylifera; Arecaceae), fig (Ficus spp. Moraceae), jujube (Ziziphus zizyphus; Rhamnaceae), olive (Olea europea; Oleaceae), pomegranate (Punica granatum; Punicaceae), sycamore fig (Ficus sycomorus; Moraceae), citron (Citrus medica), clementine (Citrus reticulata var. Clementine), grapefruit (Citrus paradisi), hybrids of the preceding species, such as the orangelo, tangelo, rangpur and ugli fruit, kumquat (Fortunella), lemon (Citrus limon), lime, key lime (Citrus aurantifolia), Persian lime, also known as tahiti lime, Kaffir lime (Citrus hystix), mandarin (Citrus reticulata), orange, of which there are sweet (Citrus sinensis) and sour (Citrus aurantium) species, pomelo (also known as the shaddock) (Citrus maxima), sweet lemon (Citrus limetta), tangerine, avocado (Persea americana; Lauraceae), carob (Ceratonia siliqua; Fabaceae), feijoa (Feijoa sellowiana; Myrtaceae), guava (Psidium guajava; Myrtaceae), kumquat (Fortunella spp.; Rutaceae), longan (Euphoria longan; Sapindaceae), lúcuma (Pouteria lucuma; Sapotaceae), lychee (Litchi chinensis; Sapindaceae), passion fruit or grenadilla (Passiflora edulis and other Passiflora spp.; Passifloraceae), peanut (Arachis hypogaea; Fabaceae), pond-apple (Annona glabra; Annonaceae) also called alligator-apple and monkey-apple, strawberry guava (Psidium litorale; Myrtaceae), tamarillo or tree tomato (Cyphomandra betacea; Solanaceae), ugni (Ugni molinae; Myrtaceae), yangmei (Myrica rubra; Myricaceae), also called yamamomo, Chinese bayberry, Japanese bayberry, red bayberry, or Chinese strawberry tree, papayas acerola (Malpighia glabra; Malpighiaceae), also called West Indian Cherry or Barbados Cherry, ackee (Blighia sapida or Cupania sapida; Sapindaceae), African cherry orange (Citropsis schweinfurthii; Rutaceae), Amazon grape (Pourouma cecropiaefolia; Moraceae), araza, avocado, agai (Euterpe oleracea; Arecaceae), or assai, babaco (Carica pentagona; Caricaceae), bael (Aegle marmelos; Rutaceae), banana (Musacea spp.; Musaceae); plantain, barbadine (granadilla; maracujd-agu in Portuguese), Barbados cherry (Malpighia glabra L.; Malpighiaceae), also called acerola, West Indian Cherry, betel nut, bilimbi (Averrhoa bilimbi; Oxalidaceae) also called cucumber tree or tree sorrel, biriba, bitter gourd, black sapote, bottle gourd, brazil nut, breadfruit (Artocarpus altilis; Moraceae), Burmese grape (Baccaurea sapida; Cucurbitaceae), calabash (Lagenaria siceraria; Bignoniaceae), calabashtree, CamuCamu (Myrciaria dubia; Myrtaceae), canistel, cape gooseberry, carambola (Averrhoa carambola; Oxalidaceae), also called star fruit or five fingers, cashew, cempedak or champedak (Artocarpus champeden; Moraceae), ceylon gooseberry, chenet (guinep or ackee; pitomba-das-Guinas in Portuguese), cherimoya (Annona cherimola; Annonaceae), chili pepper, caimito (caimite; related to the yellow abiu—egg fruit), cacao, coconut (Cocos spp.; Arecaceae), coffee, cupuagu, custard apple (Annona reticulata; Annonaceae), also called Bullock's Heart, Damson plum (Chrysophyllum oliviforme; Sapotaceae), also called catin leaf, date, date-plum (Diospyros lotus; Ebenaceae), dragonfruit (Hylocereus spp.; Cactaceae), also called pitaya, durian (Durio spp.; Bombacaceae), eggfruit (Pouteria campechiana; Sapotaceae), also called canistel or yellow sapote, elephant apple (Dillenia indica; Dilleniaceae), giant granadilla, guarana (Paullinia cupana; Sapindaceae), guava, guavaberry or rumberry; (Myrciaria floribunda; Myrtaceae), hog plum (taperebi in Portuguese), huito (Genipa americana; Rubiaceae); also called jagua, genipap, jenipapo, Indian almond, Indian fig, Indian jujube, Indian Prune (Flacourtia rukan; Flacourtiaceae), jaboticaba (Myrciaria cauliflora; Myrtaceae), also called Brazilian grape tree, jackfruit (Artocarpus heterophyllus Moraceae), also called nangka, jambul (Syzygium cumini; Myrtaceae), jatobi (Hymenae coubaril; Leguminosae; Caesalpinioideae), jocote, also called Jamaica plum, kandis (Garcinia forbesii; Clusiaceae), keppel fruit (Stelechocarpus burakol; Annonaceae), kumquat, kundong (Garcinia sp.; Clusiaceae), lablab, langsat (Lansium domesticum), also called longkong or duku, lansones (Lansium domesticum spp.; Meliaceae), leucaena, longan, loquat, lucuma, mabolo (Diospyros discolor; Ebenaceae) also known as a velvet persimmon, macadamia, Mamey sapote (Pouteria sapota; Sapotaceae); also known as mamee apple; abricõ in Portuguese mamoncillo (Melicoccus bijugatus; Sapindaceae), also known as quenepa, genip or Fijian Longan, Manila tamarind (or Monkeypod, Pithecellobium dulce), mango (Mangifera indica; Anacardiaceae), mangosteen (Garcinia mangostana; Clusiaceae), marang (Artocarpus odoratissima; Moraceae), a breadfruit relative, melinjo, melon pear, monstera (Monstera deliciosa; Araceae) also called swiss cheese plant, split-leaf philodendron, morinda, mountain soursop, mundu, mung bean, muskmelon, nance, naranjilla, lulo (Solanum quitoense; Solanaceae), nutmeg, neem, oil palm, okra, papaya (Carica papaya; Caricaceae), peach palm, peanut butter fruit (Bunchosia argentea; Malpighiaceae), pequi or souari nut (Caryocar brasiliense; Caryocaraceae), pewa (peach palm; pupunha in Portuguese), pigeon pea, pili nut, pineapple (Ananas comosus or Ananas sativas; Bromeliaceae), pitomba (Eugenia luschnathiana or Talisia esculenta), poha or cape gooseberry (Physalis peruviana; Solanaceae), pois doux (Inga edulis, ice-cream bean, or inga-cipó in Portuguese), poisonleaf (Dichapetalum cymosum), pommecythère or pomcite (Spondias cytherea); also known as golden apple, june plum or Jew plum and ambarella, and as cajamanga in Portuguese, pommerac (Eugenia malaccensis); also known as otaheite apple; malay apple; jambo in Portuguese, pulasan, pummelo, pupunha or peach-palm (Bactris gasipaes; Palmae); also known as pewa, Queensland nut, rambutan (Nephelium lappaceum; Sapindaceae), red mombin (Spondias purpurea; Anacardiaceae), riberry (Syzygium luehmannii; Myrtaceae), also called lilly pilly, lillipilli, Chinese apple, ridged gourd, salak (Salacca edulis), also called snakefruit, santol (Sandoricum koetjape; Meliaceae), sapodilla (Achras/Manilkara zapota; Sapotaceae), also called chiku, mespel, naseberry, sapadilla, snake fruit, sawo, sea grape, soncoya, soursop (Annona muricata; Annonaceae), also called guanabana, soybean, star apple (Chrysophyllum cainito), also called caimito or caimite, strawberry guava, strawberry pear, sugar apple (Annona squamosa; Annonaceae); sta, summer squash, surinam cherry (Eugenia uniflora; Myrtaceae) also called Brazilian cherry, cayenne cherry, pitanga, sweet granadilla, sweet orange, sweet pepper, sweetsop, rose apple (Syzygium jambos; Myrtaceae), also called Malay apple, tamarind (Tamarindus indica; Caesalpiniaceae), vanilla, water apple, watermelon, wax apple (Syzygium samarangense), wax gourd, white sapote, and winged bean.

The food product may be a vegetable. Non-limiting examples of vegetables may include leafy and salad vegetables such as amaranth (Amaranthus cruentus), bitterleaf (Vernonia calvoana), bok choy (Brassica rapa Pekinensis and Chinensis groups), brussels sprout (Brassica oleracea Gemmifera group), cabbage (Brassica oleracea Capitata group), catsear (Hypochaeris radicata), celtuce (Lactuca sativa var. asparagina), ceylon spinach (Basella alba), chicory (Cichorium intybus), chinese mallow (Malva verticillata), chrysanthemum (Chrysanthemum coronarium), corn salad (Valerianella locusta), cress (Lepidium sativum), dandelion (Taraxacum officinale), endive (Cichorium endivia), epazote (Chenopodium ambrosioides), fat hen (Chenopodium album), fiddlehead (Pteridium aquilinum, Athyrium esculentum), fluted pumpkin (Telfairia occidentalis), golden samphire (Inula crithmoides), good king henry (Chenopodium bonus-henricus), ice plant (Mesembryanthemum crystallinum), kai-ian (Brassica rapa Alboglabra group), komatsuna (Brassica rapa Pervidis or Komatsuna group), kuka (Adansonia spp.), lagos bologi (Talinum fruticosum), land cress (Barbarea verna), lettuce (Lactuca sativa), lizard's tail (Houttuynia cordata), melokhia (Corchorus olitorius, Corchorus capsularis), mizuna greens (Brassica rapa Nipposinica group), mustard (Sinapis alba), New Zealand spinach (Tetragonia tetragonioides), orache (Atriplex hortensis), polk (Phytolacca americana), radicchio (Cichorium intybus), garden rocket (Eruca sativa), samphire (Crithmum maritimum), sea beet (Beta vulgaris subsp. maritima), seakale (Crambe maritima), Sierra Leone bologi (Crassocephalum spp.), soko (Celosia argentea), sorrel (Rumex acetosa), spinach (Spinacia oleracea), summer purslane (Portulaca oleracea), swiss chard (Beta vulgaris subsp. cicla var. flavescens), tatsoi (Brassica rapa Rosularis group), watercress (Nasturtium officinale), water spinach (Ipomoea aquatica) and winter purslane (Claytonia perfoliata); fruiting and flowering vegetables such as Armenian cucumber (Cucumis melo Flexuosus group), eggplant or aubergine (Solanum melongena), avocado (Persea americana), bell pepper (Capsicum annuum), bitter melon (Momordica charantia), caigua (Cyclanthera pedata), cape gooseberry (Physalis peruviana), cayenne pepper (Capsicum frutescens), chayote (Sechium edule), chili pepper (Capsicum annuum Longum group), cucumber (Cucumis sativus), globe artichoke (Cynara scolymus), luffa (Luffa acutangula, Luffa aegyptiaca), malabar gourd (Cucurbita ficifolia), marrow (Cucurbita pepo), parwal (Trichosanthes dioica), perennial cucumber (Coccinia grandis), pumpkin (Cucurbita maxima, Cucurbita pepo), pattypan squash, snake gourd (Trichosanthes cucumerina), sweetcorn (Zea mays), sweet pepper (Capsicum annuum Grossum group), tinda (Praecitrullus fistulosus), tomato (Solanum lycopersicum), tomatillo (Physalis philadelphica), winter melon (Benincasa hispida), West Indian gherkin (Cucumis anguria) and zucchini or courgette (Cucurbita pepo); bulb and stem vegetables such as asparagus (Asparagus officinalis), cardoon (Cynara cardunculus), celeriac (Apium graveolens var. rapaceum), celery (Apium graveolens), elephant garlic (Allium ampeloprasum var. ampeloprasum), florence fennel (Foeniculum vulgare var. dulce), garlic (Allium sativum), kohlrabi (Brassica oleracea Gongylodes group), kurrat (Allium ampeloprasum var. kurrat), leek (Allium porrum), nopal (Opuntia ficus-indica), onion (Allium cepa), prussian asparagus (Ornithogalum pyrenaicum), shallot (Allium cepa Aggregatum group), welsh onion (Allium fistulosum) and wild leek (Allium tricoccum); root and tuberous vegetables such as acorn squash (Cucurbita pepo), ahipa (Pachyrhizus ahipa), arracacha (Arracacia xanthorrhiza), bamboo shoot (Phyllostachys edulis, Dendrocalamus latiflorus, Bambusa oldhamii, Phyllostachys bambusoides, Bambusa odashimae, Fargesia spathacea, Bambusa blumeana), beetroot (Beta vulgaris subsp. vulgaris), black cumin (Bunium persicum), broadleaf arrowhead (Sagittaria latifolia), canna (Canna spp.), carrot (Daucus carota), cassava (Manihot esculenta), chinese artichoke (Stachys affinis), daikon (Raphanus sativus Longipinnatus group), earthnut pea (Lathyrus tuberosus), elephant foot yam (Amorphophallus paeoniifolius), ensete (Ensete ventricosum), ginger (Zingiber officinale), gobo (Arctium lappa), hamburg parsley (Petroselinum crispum var. tuberosum), Jerusalem artichoke (Helianthus tuberosus), jicama (Pachyrhizus erosus), parsnip (Pastinaca sativa), pignut (Conopodium majus), plectranthus (Plectranthus spp.), potato (Solanum tuberosum), prairie turnip (Psoralea esculenta), radish (Raphanus sativus), rutabaga (Brassica napus Napobrassica group), salsify (Tragopogon porrifolius), scorzonera (Scorzonera hispanica), skirret (Sium sisarum), sweet Potato (Kumara), taro (Colocasia esculenta), tigernut (Cyperus esculentus), tomato (Solanum lycopersicum), turnip (Brassica rapa Rapifera group), ulluco (Ullucus tuberosus), wasabi (Wasabia japonica), water chestnut (Eleocharis dulcis), yacón (Smallanthus sonchifolius), and yam (Dioscorea spp.).

The edible composition may be applied to a food product using various methods. The edible composition may be rapidly sprayed, cast, or brushed in thin layers or sprayed and coated numerous times on the surface of the food product.

Various coating techniques include, but are not limited to, spray coating, dip coating, using a paint brush, or wiping. The edible composition may be applied more than one time to ensure the food product is adequately covered.

Properties of a Food Surface after Contact with the Edible Composition

The food product, after contact with the edible composition, are free of more than 99% of pathogens present on the surface of a food product as compared to a food product that had not been treated with the edible composition, and the freshness and quality of the food product would extend for more than 14 days. In one embodiment, the food product is free of 99-99.5% of pathogens. In one embodiment, the food product is free of 99-99.9% of pathogens.

### EXAMPLES

While the present invention is disclosed in reference to the embodiments or examples above, it is to be understood that these embodiments or examples are intended for illustrative purposes, which shall not be treated as limitations to the present invention. It is contemplated that modifications and combinations will readily occur to those skilled in the art, which modifications and combinations will be within the spirit of the invention and the scope of the following claims.

### Materials and Instruments

The following materials were sourced in the Examples noted below. 1,4-Phenylene diisocyanate, polyethylene glycol, methyl acrylate, acrylonitrile, diphenyl carbonate, and 1,1-bis(4-hydroxyphenyl)cyclohexane were purchased from Sigma and used without further purification. The purity of these reagents was greater than 99%. Silver nitrate, silver chloride, copper (II) acetate, zinc acetate, zinc citrate, and silver lactate were sourced from Rochester Silver, Rochester, NY, Alpha Chemika, or Sigma Aldrich and used without further purification. The minimum purity of these reagents was 99% minimum.

The pH of the metal ion disinfectant composition was determined using a Systonic digital auto pH meter with Combination pH Electrode calibrated with a pH 7.0 buffer. The concentration of silver ions in the samples was determined by an inductively coupled plasma optical emission spectrometry (ICP-OES) method or potentiometric titration using 1 drop nitric acid and titrating with 100 ppm solution of sodium chloride.

The concentration of other metal ions was determined in a similar fashion.

The following materials were sourced in the Examples noted below: Silver nitrate, silver chloride, copper (II) acetate, zinc acetate, zinc citrate, and silver lactate were sourced from Rochester Silver, Rochester, NY, Alpha Chemika, or Sigma Aldrich and used without further purification. The minimum assay of these reagents was 99% minimum.

The pH of the composition was determined using a Systonic digital auto pH meter with Combination pH Electrode calibrated with a pH 7.0 buffer. The concentration of silver ions in the samples was determined by an inductively coupled plasma optical emission spectrometry (ICP-OES) method or potentiometric titration using 1 drop nitric acid and titrating with 100 ppm solution of sodium chloride.

### Example 1: Isolation of Plant Waxes

Ten fresh tomatoes are obtained that may be fully ripe and undamaged. The tomatoes are cut in pieces removing the pulp and seeds of the tomatoes. The tomatoes are placed into a blender and blended until the cuticle may be separated from the pulp. The mixture is strained through a piece of cheese cloth removing any additional pulp or seeds. The filtrate is extracted using hexanes and precipitated. The precipitate is dried under vacuum at room temperature for 24 hours. The resultant plant waxes are characterized by FTIR and GC-MS.

### Example 2: Preparation of a Composition Comprising Plant Wax, Tween 80@, Silver Nitrate, and Water

Into a round bottom flask is added 1.50 g of Tween 80® and 96.4 mL of distilled water. This mixture is stirred using a magnetic stirrer at 75° C. for 20 minutes. Then, 2.0 g of plant wax (from Example 1) is added slowly into the solution. After the addition of the plant wax is complete, this mixture is stirred for an additional 15 minutes at 75° C. until a homogeneous mixture is visually determined. 0.1 g of silver nitrate is slowly added to the homogeneous mixture containing the plant wax, Tween 80®, silver nitrate and water. The mixture is stirred for 30 minutes to cool to room temperature until an emulsion is visually determined. The emulsion is stored in a capped glass bottle at 0° C.

An ASTM E-2315 test is conducted under guidelines of the AOAC (Association of Official Analytical Chemists). The samples show greater than 99% reduction on exposure to Escherichia coli when exposed for just 15 seconds, thereby demonstrating instant killing activity of the composition as compared to the control. Similar tests are conducted with Staphylococcus aureus (ATCC 25923) and Pseudomonas aeruginosa (ATCC 9027) showing the same instant kill rate of the composition as compared to the control.

### Example 3: Composition Derived from Plant Wax, Polysorbate 80, Silver Nitrate, Essential Oil and Water

Into a round bottom flask is added 2.0 g of polysorbate 80 and 96.9 mL of distilled water. This mixture is stirred using a magnetic stirrer at 75° C. for 20 minutes. Then, 1.0 g of the plant wax (from Example 1) is added slowly into the solution. After the addition of the plant wax is complete, the mixture is stirred for an additional 15 minutes at 75° C. until a homogeneous mixture is visually determined. Then, 2.0 g of cinnamon oil and/or eucalyptus oil are slowly added into the solution. After the addition of the essential oil is complete, this mixture is stirred for an additional 15 minutes at 75° C. until a homogeneous mixture is visually determined. Next, 0.1 g of silver nitrate is slowly added to the homogeneous mixture containing the essential oil, polysorbate 80, and water. The mixture is stirred for 30 minutes to cool to room temperature until an emulsion is visually determined. The emulsion may be stored in a capped glass bottle at 0° C.

An ASTM E-2315 test is conducted under guidelines of the AOAC (Association of Official Analytical Chemists). The samples show greater than 99% reduction on exposure to Escherichia coli when exposed for just 15 seconds, thereby demonstrating instant killing activity of the composition as compared to the control. Similar tests are conducted with Staphylococcus aureus (ATCC 25923) and Pseudomonas aeruginosa (ATCC 9027) showing the same instant kill rate of the composition as compared to the control.

### Example 4: Preparation of a Composition Derived from Zein Powder, Silver Nitrate, and Water to Apply on Apples

Into a round bottom flask is added 10 g of zein powder and 89.8 mL of distilled water. This mixture is stirred using a magnetic stirrer at room temperature for 20 minutes until a homogeneous solution is obtained visually. Then, 0.2 g of silver nitrate is added slowly into the zein solution. After the addition of the silver nitrate is complete, the mixture is stirred for an additional 15 minutes at room temperature until a homogeneous mixture is visually determined. The mixture is stirred for 30 minutes. The composition is stored in a capped glass bottle at room temperature.

An ASTM E-2315 test is conducted under guidelines of the AOAC (Association of Official Analytical Chemists) and other test methods include three strains of Listeria monocytogenes (ATCC 49594, 19114, 19116), three strains of Escherichia coli serotype O157:H7 (ATCC 43895, 35150, 43890), and three strains of Salmonella choleraesuis subsp. choleraesuis (serotype javiana ATCC 10721, serotype newport ATCC 6962, serotype typhirmirium ATCC 13311). Two sets of apples, each set containing three apples. One set, the control set, are placed at room temperature and 50% Relative humidity. The second set, the treatment group, is sprayed with the composition. The control group may show discoloration and may show an increase in bacteria. The treatment group shows greater than 99% reduction of bacteria.

### Example 5: Preparation of a Composition Derived from Zein Powder, Zinc Nitrate, and Water to Apply on Apples

Into a round bottom flask is added 9.5 g of zein powder and 90.0 mL of distilled water. This mixture is stirred using a magnetic stirrer at room temperature for 20 minutes until a homogeneous solution is obtained visually. Then, 0.5 g of zinc nitrate is added slowly into the zein solution. After the addition of the zinc nitrate is complete, this mixture is stirred for an additional 15 minutes at room temperature until a homogeneous mixture is visually determined. The mixture is stirred for 30 minutes. The composition is stored in a capped glass bottle at room temperature.

An ASTM E-2315 is conducted under guidelines of the AOAC (Association of Official Analytical Chemists) and other test methods include three strains of Listeria monocytogenes (ATCC 49594, 19114, 19116), three strains of Escherichia coli serotype O157:H7 (ATCC 43895, 35150, 43890), and three strains of Salmonella choleraesuis subsp. choleraesuis (serotype javiana ATCC 10721, serotype newport ATCC 6962, serotype typhirmirium ATCC 13311).

Starting with two sets of apples, each set containing three apples. One set, the control set, are placed at room temperature and 50% Relative humidity. The second set, the treatment group, is sprayed with the composition. Each set of apples is separately tested in the methods noted above. The control group may show discoloration and may show an increase in bacteria. The treatment group show greater than 99% reduction of bacteria.

### Example 6: Blueberries Treated with Zein

Starting with two sets of blueberries, each set containing five blueberries, a control set is dipped in 95% ethanol and placed at room temperature and 50% Relative humidity. A second set, the treatment set, is dipped in a zein composition consisting of 100 mL 95% Ethanol+6 g zein powder. Blueberries were weighed on days 1, 2, 3, 4, 5, 6, 7, 8, 9. Weights were taken to approximate moisture retention and freshness. After nine days, average weight loss of control (no zein applied) blueberries was 43.1% compared to 37.2% weight loss for zein treatment. Blueberries treated with zein retained 13.7% more moisture compared to untreated berries. Results are summarized in Tables 1A-1B.

TABLE 1A
Weight (grams) of blueberries treated with zein and incubated at 23-25° C.

| Sample | Day | Day | Day | Day | Day | Day | Day | Day | Day | Day | Day |
|---|---|---|---|---|---|---|---|---|---|---|---|
| No. | 1 | 2 | 3 | 5 | 6 | 7 | 8 | 11 | 12 | 13 | 14 |
| 1 | 1.79 | 1.7 | 1.44 | 1.3 | 1.22 | 1.16 | 1.1 | 1.06 | 0.98 | 0.86 | 0.832 |
| 2 | 1.62 | 1.53 | 1.6 | 1.65 | 1.37 | 1.31 | 1.26 | 1.2 | 1.12 | 1.01 | 0.98 |
| 3 | 1.71 | 1.63 | 1.54 | 1.99 | 1.32 | 1.26 | 1.19 | 1.15 | 1.08 | 0.97 | 0.94 |
| 4 | 1.7 | 1.63 | 1.55 | 1.63 | 1.36 | 1.3 | 1.26 | 1.19 | 1.13 | 1.01 | 0.98 |
| 5 | 1.6 | 1.52 | 1.44 | 1.3 | 1.23 | 1.16 | 1.09 | 1.06 | 0.97 | 0.85 | 0.82 |

6 grams of powdered zein was dissolved in 100 mL of 95% ethanol and fruit was dipped in the resulting solution

TABLE 1B
Control, weight (grams) of untreated blueberries incubated at 23-25° C.

| Sample | Day | Day | Day | Day | Day | Day | Day | Day | Day | Day | Day |
|---|---|---|---|---|---|---|---|---|---|---|---|
| No. | 1 | 2 | 3 | 5 | 6 | 7 | 8 | 11 | 12 | 13 | 14 |
| 1 | 1.51 | 1.61 | 1.62 | 1.28 | 1.21 | 1.16 | 1.1 | 1.06 | 1.01 | 0.91 | 0.89 |
| 2 | 1.7 | 1.59 | 1.47 | 1.32 | 1.26 | 1.19 | 1.12 | 1.08 | 1.01 | 0.91 | 0.88 |
| 3 | 1.6 | 1.5 | 1.32 | 1.18 | 1.11 | 1.05 | 0.99 | 0.96 | 0.8 | 0.78 | 0.76 |
| 4 | 2.17 | 1.99 | 1.81 | 1.61 | 1.5 | 1.43 | 1.34 | 1.29 | 1.2 | 1.06 | 1.03 |
| 5 | 1.36 | 1.25 | 1.44 | 1.01 | 0.96 | 0.8 | 0.82 | 0.77 | 0.71 | 0.61 | 0.58 |

Fruit was untreated

### Example 7: Blueberries Treated with Zein and Silver Nitrate

Starting with two sets of blueberries, each set containing six blueberries, a control set is dipped in 95% ethanol and placed at room temperature and 50% Relative humidity. A second set, the treatment set is dipped in a zein composition consisting of 100 mL 95% Ethanol+6 g zein powder+100 ppm AgNO3. Blueberries were weighed on days 1, 3, 4, 5, 6, 7. Weights were taken to approximate moisture retention and freshness. After 7 days, average weight loss of control (no treatment) blueberries was 24.6% compared to 20.8% weight loss for zein+AgNO3 treatment. Blueberries treated with zein+AgNO3 retained 15.4% more moisture compared to untreated berries. Results are summarized in Tables 2A-2B.

TABLE 2A
Weight (grams) of blueberries treated with
zein and AgNO₃ and incubated at 23-25° C.

| Sample | Day | Day | Day | Day | Day | Day |
|---|---|---|---|---|---|---|
| No. | 1 | 2 | 3 | 4 | 6 | 7 |
| 1 | 1.86 | 1.71 | 1.66 | 1.5 | 1.54 | 1.47 |
| 2 | 2.02 | 1.87 | 1.82 | 1.75 | 1.7 | 1.63 |
| 3 | 1.96 | 1.79 | 1.73 | 1.65 | 1.6 | 1.52 |
| 4 | 1.29 | 1.18 | 1.16 | 1.08 | 1.03 | 0.97 |
| 5 | 1.86 | 1.73 | 1.69 | 1.62 | 1.57 | 1.5 |
| 6 | 1.63 | 1.51 | 1.68 | 1.41 | 1.37 | 1.31 |

6 grams of powdered zein was dissolved in 100 mL of 95% ethanol and fruit was dipped in the resulting solution

TABLE 2B
Control, weight (grams) untreated
blueberries incubated at 23-25° C.

| Sample | Day | Day | Day | Day | Day | Day |
|---|---|---|---|---|---|---|
| No. | 1 | 2 | 3 | 4 | 6 | 7 |
| 1 | 1.6 | 1.46 | 1.43 | 1.36 | 1.32 | 1.26 |
| 2 | 1.56 | 1.36 | 1.3 | 1.19 | 1.13 | 1.03 |
| 3 | 1.7 | 1.56 | 1.52 | 1.44 | 1.39 | 1.33 |
| 4 | 1.77 | 1.62 | 1.57 | 1.69 | 1.44 | 1.37 |
| 5 | 2.12 | 1.93 | 1.87 | 1.76 | 1.69 | 1.6 |
| 6 | 1.85 | 1.69 | 1.64 | 1.54 | 1.48 | 1.41 |

Fruit was untreated

### Example 8: Java Plum with Zein

Starting with two sets of java plums, each set containing eight plums, a control set is dipped in 95% ethanol and placed at room temperature and 50% Relative humidity. A second set, the treatment set, is dipped in a zein composition consisting of 100 mL 95% Ethanol+6 g zein powder. Blueberries were weighed on days 1, 2, 3, 4, 6, 7. Weights were taken to approximate moisture retention and freshness. After 7 days, average weight loss of control (no zein applied) Java plums was 28.5% compared to 23.6% weight loss for zein treatment. Java plums treated with zein retained 17.2% more moisture compared to untreated plums. Results are summarized in Tables 3A-3B.

TABLE 3A
Weight (grams) of Java plums treated
with zein and incubated at 23-25° C.

| Sample | Day | Day | Day | Day | Day | Day |
|---|---|---|---|---|---|---|
| No. | 1 | 2 | 3 | 4 | 6 | 7 |
| 1 | 14.65 | 13.13 | x | x | x | x |
| 2 | 14.35 | 13.63 | 19.13 | 12.67 | 11.39 | 11.03 |
| 3 | 12.88 | 12.24 | 11.78 | 11.18 | 10.2 | 9.87 |
| 4 | 15.82 | 15.03 | 14.46 | 13.72 | 12.53 | 12.15 |
| 5 | 15.19 | 14.42 | 13.88 | 13.16 | 12.02 | 11.66 |
| 6 | 11.63 | 10.79 | 10.33 | 9.72 | 8.73 | 8.4 |
| 7 | 11.83 | 11.19 | 10.72 | 9.12 | x | x |
| 8 | 16.16 | 13.65 | 12.96 | 12.36 | 11.33 | 11 |

6 grams of powdered zein was dissolved in 100 mL of 95% ethanol and fruit was dipped in the resulting solution

TABLE 3B
Control, weight (grams) of untreated
Java plums incubated at 23-25° C.

| Sample | Day | Day | Day | Day | Day | Day |
|---|---|---|---|---|---|---|
| No. | 1 | 2 | 3 | 4 | 6 | 7 |
| 1 | 9.15 | 8.58 | | | | |
| 2 | 10.63 | 9.88 | 9.35 | 8.64 | 7.53 | 7.2 |
| 3 | 16.12 | 15.03 | 14.2 | 13.26 | 11.49 | 10.8 |
| 4 | 12.66 | 11.73 | 11.25 | 10.58 | 9.54 | 9.23 |
| 5 | 12.86 | 12.16 | 11.7 | 11.08 | 10.08 | 9.75 |
| 6 | 13.59 | 12.86 | 12.37 | 11.7 | 10.66 | 10.33 |
| 7 | 11.97 | 11.26 | 10.77 | 8.21 | x | x |
| 8 | 8.5 | 7.96 | 7.55 | 6.98 | 6.08 | 5.8 |

Fruit was untreated

### Example 9: Blueberries Treated with Cutin

Starting with two sets of blueberries, each set containing fifteen blueberries, a control set is dipped in 90% ethanol (pH 6) and placed at room temperature and 50% Relative humidity. The second set, the treatment set are dipped in a cutin composition consisting of 100 mL 90% ethanol (pH 6)+1.25 g cutin. Blueberries were weighed on days 1, 2, 3, 4, 6. Weights were taken to approximate moisture retention and freshness. After 6 days, average weight loss of control (no cutin applied) blueberries was 17.3% compared to 14.6% weight loss for cutin treatment. Blueberries treated with cutin retained 15.6% more moisture compared to untreated blueberries. Results are summarized in Tables 4A-4B.

TABLE 4A
Weight (grams) of blueberries treated
with cutin and incubated at 23-25° C.

| Sample | Day | Day | Day | Day | Day |
|---|---|---|---|---|---|
| No. | 1 | 2 | 3 | 4 | 6 |
| 1 | 2.19 | 2.12 | 2.06 | 2 | 1.86 |
| 2 | 2.89 | 2.8 | 2.68 | 2.58 | 2.41 |
| 3 | 2.82 | 2.74 | 2.66 | 2.58 | 2.43 |
| 4 | 1.87 | 1.79 | 1.73 | 1.63 | 1.51 |
| 5 | 2.28 | 2.21 | 2.12 | 2.0 | 1.94 |
| 6 | 2.27 | 2.21 | 2.16 | 2.09 | 2.0 |
| 7 | 2.77 | 2.69 | 2.64 | 2.57 | 2.49 |
| 8 | 2.31 | 2.24 | 2.16 | 2.1 | 2.0 |
| 9 | 2.78 | 2.68 | 2.6 | 2.52 | 2.41 |
| 10 | 2.59 | 2.51 | 2.45 | 2.38 | 2.25 |
| 11 | 2.78 | 2.69 | 2.62 | 2.5 | 2.38 |
| 12 | 2.86 | 2.77 | 2.67 | 2.56 | 2.43 |
| 13 | 2.43 | 2.35 | 2.27 | 2.19 | 2.08 |
| 14 | 1.88 | 1.8 | 1.75 | 1.64 | 1.51 |
| 15 | 1.92 | 1.82 | 1.76 | 1.68 | 1.59 |

1.25 grams of cutin was dissolved in 100 mL of 90% ethanol (pH 6) and fruit was dipped in the resulting solution

TABLE 4B
Control, weight (grams) of untreated
blueberries incubated at 23-25° C.

| Sample | Day | Day | Day | Day | Day |
|---|---|---|---|---|---|
| No. | 1 | 2 | 3 | 4 | 6 |
| 1 | 1.92 | 1.86 | 1.79 | 1.7 | 1.56 |
| 2 | 2.62 | 2.56 | 2.49 | 2.35 | 2.05 |
| 3 | 2.9 | 2.8 | 2.65 | 2.47 | 2.22 |
| 4 | 1.88 | 1.7 | 1.74 | 1.66 | 1.56 |
| 5 | 2.13 | 2.07 | 2.0 | 1.9 | 1.68 |
| 6 | 2.05 | 2.0 | 1.92 | 1.84 | 1.72 |
| 7 | 2.18 | 2.11 | 2 | 1.92 | 1.82 |
| 8 | 1.74 | 1.68 | 1.63 | 1.54 | 1.47 |
| 9 | 2.75 | 2.71 | 2.61 | 2.47 | 2.36 |
| 10 | 2.09 | 2.0 | 1.93 | 1.83 | 1.75 |
| 11 | 3.11 | 3.04 | 3.0 | 2.86 | 2.76 |
| 12 | 2.38 | 2.3 | 2.2 | 2.07 | 1.95 |
| 13 | 2.24 | 2.15 | 2.1 | 2.0 | 1.86 |
| 14 | 2.0 | 1.9 | 1.84 | 1.78 | 1.68 |
| 15 | 2.14 | 2.08 | 2.0 | 1.68 | 1.77 |

Fruit was untreated

### Example 10: Strawberries Treated with Cutin

Starting with two sets of strawberries, each set containing ten strawberries, a control set is dipped in distilled water (pH 7) and placed at room temperature and 50% Relative humidity. The second set, the treatment set are dipped in a cutin composition consisting of 100 mL distilled water (pH 7)+1.8 g cutin. Strawberries were weighed on days 1, 2, 3, 4. Weights were taken to approximate moisture retention and freshness. After four days, average weight loss of control (no cutin applied) strawberries was 56.1% compared to 48.4% weight loss for cutin treatment. Strawberries treated with cutin retained 13.7% more moisture compared to untreated strawberries. Results are summarized in Tables 5A-5B.

TABLE 5A
Weight (grams) of strawberries treated
with cutin and incubated at 23-24° C.

| Sample | Day | Day | Day | Day |
|---|---|---|---|---|
| No. | 1 | 2 | 3 | 4 |
| 1 | 12.49 | 10.74 | 9.12 | 8.26 |
| 2 | 6.54 | 5.16 | 3.86 | 3.17 |
| 3 | 12.13 | 9.67 | 7.39 | 6.24 |
| 4 | 5.04 | 4.04 | 3.13 | 2.66 |
| 5 | 5.17 | 4.0 | 2.92 | 2.37 |
| 6 | 10.13 | 8.37 | 6.73 | 5.9 |
| 7 | 6.75 | 5.25 | 3.79 | 3.07 |
| 8 | 5.82 | 4.79 | 3.78 | 3.25 |
| 9 | 9.22 | 7.8 | 6.49 | 5.8 |
| 10 | 6.41 | 4.24 | 2.55 | 1.87 |

1.8 grams of cutin dissolved in 100 mL of distilled water (pH 7) and fruit was dipped in the resulting solution

TABLE 5B
Control, weight (grams) of untreated
strawberries incubated at 23-24° C.

| Sample | Day | Day | Day | Day |
|---|---|---|---|---|
| No. | 1 | 2 | 3 | 4 |
| 1 | 8.56 | 6.75 | 4.96 | 4.04 |
| 2 | 5.2 | 4.29 | 3.32 | 2.78 |
| 3 | 8.65 | 7.27 | 5.85 | 5.09 |
| 4 | 5.28 | 3.77 | 2.301 | 1.67 |
| 5 | 5.47 | 4.08 | 3.0 | 2.48 |
| 6 | 6.05 | 4.68 | 3.43 | 2.78 |
| 7 | 5.36 | 4.29 | 3.32 | 2.82 |
| 8 | 8.0 | 5.35 | 3.26 | 2.43 |
| 9 | 10.36 | 8.15 | 6.16 | 5.17 |
| 10 | 4.19 | 2.73 | 1.49 | 1.0 |

Fruit was untreated

### Example 11: Blueberries Treated with Recombinant Cutin

Starting with two sets of blueberries, each set containing fifteen blueberries, a control set, is dipped in 90% ethanol (pH 6) and placed at room temperature and 50% Relative humidity. The second set, the treatment set are dipped in a cutin composition consisting of 100 mL 90% ethanol (pH 6)+1.25 g cutin. Blueberries were weighed on days 1, 2, 3, 4, 6. Weights were taken to approximate moisture retention and freshness. After 6 days, average weight loss of control (no cutin applied) blueberries was 17.3% compared to 14.6% weight loss for cutin treatment. Blueberries treated with recombinant cutin retained 15.6% more moisture compared to untreated blueberries.

### METHODS

Lithium transformation of yeast cells done as described in “Methods in Yeast Genetics: A Cold Spring Harbor Laboratory Course Manual”, 2005 Edition
YPD agar plates consist of YPD media composed of yeast extract (10 g/L), Bacto peptone (20 g/L), and dextrose (20 g/L) in 1 L of (deionized or distilled) H₂O, pH to 5.5.

What is claimed is:

1. An edible composition for the preservation of a food product, the edible composition comprising: about 0.1 weight percent (wt. %) to about 5.0 wt. % of at least one metal ion; about 1 wt. % to about 10 wt. % of a plant wax; about 1 wt. % to about 5 wt. % of an emulsifying agent; and about 80 wt. % to about 98 wt. % of a solvent.

2. The edible composition of claim 1, wherein the at least one metal ion is a food safe metal ion.

3. The edible composition of claim 2, wherein the food safe metal ion comprises a water-soluble metal salt.

4. The edible composition of claim 3, wherein the at least one metal ion comprises a silver salt, a copper salt, a zinc salt, a gold salt, a cobalt salt, a zirconium salt, a molybdenum salt, a palladium salt, a platinum salt, or a combination thereof.

5. The edible composition of claim 1, wherein the plant wax comprises cutin, carnauba wax, soy wax, jojoba wax, candelilla wax, rice bran wax, or a combination thereof.

6. The edible composition of claim 1, wherein the emulsifying agent comprises lecithin, a monoglyceride, a diglyceride, a polysorbate, a carrageenan, a polyglycerol of a fatty acid, a sorbitol ester, a beeswax, or combinations thereof.

7. The edible composition of claim 6, wherein the emulsify agent comprises polysorbate 80, sodium stearoyl lactylate, propylene glycol, tween 80, and sodium caseinate.

8. The edible composition of claim 1, wherein the solvent comprises a polar protic, a polar aprotic, a non-polar protic solvent, or a combination thereof.

9. The edible composition of claim 8, wherein the solvent comprises water.

10. The edible composition of claim 1, further comprising an acceptable excipient selected from a group consisting of a preservative, a stabilizer, and combinations thereof.

11. The edible composition of claim 1, wherein the preservative emulsion composition has a pH from about 6.0 to about 7.0.

12. The edible composition of claim 1, wherein the preservative emulsion composition is non-toxic and non-corrosive to the food product.

13. The edible composition of claim 1, wherein the preservative emulsion composition is light stable and heat stable.

14. The edible composition of claim 1, wherein the plant wax prevents oxidation and provides a moisture barrier of the at least one metal ion on the plant product.

15. The edible composition of claim 1, wherein the preservative emulsion composition exhibits antimicrobial properties, antibacterial properties, antifungal properties, antiviral properties, or a combination thereof against a variety of pathogens on the plant product.

16. The edible composition of claim 1, wherein the preservative emulsion composition exhibits a greater than a 99% kill rate on a variety of surfaces of the food products in less than 5 minutes.

17. The edible composition of claim 1, wherein the preservative emulsion composition maintains efficacy for greater than 14 days on the plant product.

18. A method for preparing an edible composition for the preservation of food products, the method comprising the steps of combining a plant wax, an emulsifying agent, and at least one acceptable excipient in a solvent forming a plant wax emulsion; and combining the plant wax emulsion with at least one metal ion forming the edible composition of claim 1.

19. The method of claim 18, wherein the at least one metal ion is a food safe metal ion.

20. The method of claim 18, wherein the food safe metal ion is from a water-soluble metal salt.

21. The method of claim 20, wherein the at least one metal ion comprises a silver salt, a copper salt, a zinc salt, a gold salt, a cobalt salt, a zirconium salt, a molybdenum salt, a palladium salt, a platinum salt, or a combination thereof.

22. The method of claim 18, wherein the plant wax comprises cutin, carnauba wax, soy wax, jojoba wax, candelilla wax, rice bran wax, or a combination thereof.

23. The method of claim 22, wherein the emulsifying agent comprises lecithin, a monoglyceride, a diglyceride, a polysorbate, a carrageenan, a polyglycerol of a fatty acid, a sorbitol ester, a beeswax, or combinations thereof.

24. The method of claim 23, wherein the emulsifying agent comprises polysorbate 80, sodium stearoyl lactylate, propylene glycol, tween 80, and sodium caseinate.

25. The method of claim 18, wherein the solvent comprises a polar protic, a polar aprotic, a non-polar protic solvent, or a combination thereof.

26. The method of claim 25, wherein the solvent comprises water.

27. The method of claim 18, further comprising an acceptable excipient selected from a group consisting of a preservative, a stabilizer, and combinations thereof.

28. The method of claim 18, wherein the method provides a pH of the composition from about 6.0 to about 7.0 using a proton acceptor.

29. The method of claim 18, wherein the proton acceptor comprises an inorganic proton acceptor.

30. The method of claim 29, wherein the proton acceptor is selected from a group consisting of sodium hydroxide, potassium hydroxide, calcium hydroxide, barium hydroxide, ammonia, cesium carbonate, sodium bicarbonate, potassium bicarbonate, sodium carbonate, potassium carbonate, calcium carbonate, sodium borate, sodium dihydrogen phosphate, disodium hydrogen phosphate, sodium methoxide, sodium tert-butoxide, potassium tert-butoxide, sodium acetate, potassium acetate, and combination thereof.

31. The method of claim 18, wherein the method may be conducted at a temperature ranging from about 40° C. to about 100° C.

32. The method of claim 31, wherein the method may be conducted from about 70° C. to about 80° C.

33. A method of preserving a surface of a food product comprising contacting a surface of a food product with the edible composition of claim 1. The method of claim 33, wherein the food product is selected from a fruit and vegetable.

34. The method of claim 33, wherein the method kills 99% of the pathogens on the surface of the food product.

35. The method of claim 33, wherein the method preserves the food product for greater than 14 days.

36. An edible composition for the preservation of a food product, the composition comprising: about 0.001 weight % (wt. %) to about 2 wt. % of at least one metal ion; about 5 wt. % to about 20 wt. % of zein powder; and about 88 wt. % to about 95 wt. % of a solvent.

37. The edible composition of claim 37, wherein the at least one metal ion is a food safe metal ion.

38. The edible composition of claim 38, wherein the at least one metal ion is from a water-soluble metal salt.

39. The edible composition of claim 39, wherein the at least one metal salt is selected from a group consisting of a silver salt, a copper salt, a zinc salt, a gold salt, a cobalt salt, a zirconium salt, a molybdenum salt, a palladium salt, a platinum salt, and a combination thereof.

40. The edible composition of claim 40, wherein the at least one metal salt is selected from a group consisting of a copper salt, a zinc salt, and a combination thereof.

41. The edible composition of claim 37, wherein the zein powder comprises a natural source of zein, a synthetic source of zein, a derivative of zein, or a combination thereof.

42. The edible composition of claim 37, wherein the solvent comprises a polar protic, a polar aprotic, a non-polar protic solvent, or a combination thereof.

43. The edible composition of claim 43, wherein the solvent comprises water.

44. The edible composition of claim 37, further comprising at least one excipient.

45. The edible composition of claim 45, wherein the excipient comprises a preservative, a stabilizer, or a combination thereof.

46. The edible composition of claim 45, wherein the excipient comprises about 0.01 wt. % to about 1 wt. %.

47. The edible composition of claim 37, wherein the composition has a pH from about 6.0 to about 7.0.

48. The edible composition of claim 37, wherein the composition prevents wherein zein prevents oxidation and/or moisture of the at least one metal ion.

49. The edible composition of claim 37, wherein the composition provides increased freshness for a food product for greater than 14 days by maintaining water in the food product.

50. The edible composition of claim 37, wherein the preservative and disinfectant composition provides exhibits antimicrobial properties, antibacterial properties, antifungal properties, or a combination thereof against a variety of food product pathogens.

51. The edible composition of claim 37, wherein the composition is non-toxic and non-corrosive.

52. The edible composition of claim 37, wherein the composition is light and heat stable.

53. The edible composition of claim 37, wherein the zein prevents oxidation and/or moisture of the at least one metal ion.

54. The edible composition of claim 37, wherein the composition exhibits a greater than a 99% kill rate of the food product pathogens on a variety of food products in less than 5 minutes.

55. The edible composition of claim 37, wherein the composition maintains a sterilization efficacy greater than 14 days.

56. A method for preparing an edible composition for the preservation of a food product, the method comprising the steps of: combining zein powder with a solvent to form a zein solution; and combining at least one metal ion with the zein solution to form the composition of claim 37.

57. The method of claim 57, wherein the at least one metal ion is a food safe metal ion.

58. The method of claim 57, wherein the at least one metal ion is from a water-soluble metal salt.

59. The method of claim 59, wherein the at least one metal salt is selected from a group consisting of a silver salt, a copper salt, a zinc salt, a gold salt, a cobalt salt, a zirconium salt, a molybdenum salt, a palladium salt, a platinum salt, and a combination thereof.

60. The method of claim 60, wherein the at least one metal salt is selected from a group consisting of a copper salt, a zinc salt, and a combination thereof.

61. The method of claim 57, wherein the zein powder comprises a natural source of zein, a synthetic source of zein, a derivative of zein, or a combination thereof.

62. The method of claim 57, wherein the solvent comprises a polar protic, a polar aprotic, a non-polar protic solvent, or a combination thereof.

63. The method of claim 63, wherein the solvent comprises water.

64. The method of claim 57, further comprising at least one excipient.

65. The method of claim 65, wherein the at least one excipient comprises a preservative, a stabilizer, or a combination thereof.

66. The method of claim 65, wherein the at least one excipient comprises about 0.01 wt. % to about 1 wt. %.

67. The method of claim 57, wherein the composition has a pH from about 6.0 to about 7.0.

68. The method of claim 57, wherein the zein powder prevents oxidation and/or moisture of the at least one metal ion.

69. The method of claim 57, wherein the edible composition provides increased freshness for a food product for greater than 14 days by maintaining water in the food product.

70. The method of claim 57, wherein the edible composition provides exhibits antimicrobial properties, antibacterial properties, antifungal properties, or a combination thereof against a variety of food product pathogens/The method of claim 57, wherein the edible composition is non-toxic and non-corrosive.

71. The method of claim 57, wherein the edible composition is light and heat stable.

72. The method of claim 57, wherein the zein powder prevents oxidation and/or moisture of the at least one metal ion.

73. The method of claim 57, wherein the edible composition achieves a greater than a 99% kill rate of the food product pathogens on a variety of food products in less than 5 minutes.

74. The method of claim 57, wherein the edible composition maintains a sterilization efficacy greater than 14 days.

75. A method of preserving and disinfecting a food product comprising contacting the food product with the edible composition of claim 57.

76. The method of claim 75, wherein the food product comprises a fruit or a vegetable.

77. The method of claim 75, wherein the method achieves a greater than a 99% kill rate on a variety of food product pathogens in less than 5 minutes.

78. The method of claim 75, wherein the method maintains a disinfecting efficacy and freshness of the food product for greater than 14 days.

79. An edible composition for the preservation of a food product, the edible composition comprising: about 0.1 weight percent (wt. %) to about 5.0 wt. % of at least one metal ion; about 1 wt. % to about 10 wt. % of a plant wax; about 1 wt. % to about 5 wt. % of an emulsifying agent; and about 80 wt. % to about 98 wt. %.

80. The edible composition of claim 79, wherein the at least one metal ion is a food safe metal ion.

81. The edible composition of claim 80, wherein the food safe metal ion comprises a water-soluble metal salt.

82. The edible composition of claim 81, wherein the at least one metal ion comprises a silver salt, a copper salt, a zinc salt, a gold salt, a cobalt salt, a zirconium salt, a molybdenum salt, a palladium salt, a platinum salt, or a combination thereof.

83. The edible composition of claim 79, wherein the plant wax comprises recombinant cutin, carnauba wax, soy wax, jojoba wax, candelilla wax, rice bran wax, or a combination thereof.

84. The edible composition for claim 83, wherein the recombinant cutin comprises cutin expressed from DNA of a bacteria or yeast.

85. The edible composition of claim 83, wherein the bacteria comprise a plasmid containing cutin synthase gene.

86. The edible composition of claim 83, wherein the bacteria is selected from a group consisting of E. coli, Bacillus subtilis, Pseudomonas putida, Streptomyces, Corynebacterium glutamicum, Agrobacterium tumefaciens, and combinations thereof.

87. The edible composition of claim 83, wherein the cutin gene isolated from Arabidopsis thaliana and expressed in Saccharomyces cerevisiae.

88. The edible composition of claim 79, wherein the preservative composition further comprises a pH stabilizer, at least one metal ion, an essential oil, an emulsifying agent, or combinations thereof.

89. The edible composition of claim 88, wherein the pH stabilizer comprises a proton acceptor.

90. The edible composition of claim 89, wherein the proton acceptor comprises an inorganic proton acceptor.

91. The edible composition of claim 88, wherein the essential oil is selected from a group consisting of tea tree oil, thyme oil, eucalyptus oil, oregano oil, peppermint oil, rosemary oil, clove oil, cinnamon oil, lemongrass oil, and a combination thereof.

92. The edible composition of claim 79, wherein the emulsifying agent comprises lecithin, a monoglyceride, a diglyceride, a polysorbate, a carrageenan, a polyglycerol of a fatty acid, a sorbitol ester, a beeswax, or combinations thereof.

93. The edible composition of claim 92, wherein the emulsifying agent comprises polysorbate 80, sodium stearoyl lactylate, propylene glycol, Tween 80®, and sodium caseinate.

94. The edible composition of claim 79, wherein the genetically modified cutin preserves the food product for at least 14 days.

95. The edible composition of claim 79, wherein the edible composition has a pH from 6.0 to 8.0.

96. The edible composition of claim 79 wherein the edible composition is light stable, non-toxic, and non-corrosive.

97. The edible composition of claim 79, wherein the food product is a fruit or a vegetable.

98. A method for preparing an edible composition comprising:
A. culturing bacteria in a bacterial culture media;
B. transducing the bacterial culture with a plasmid comprising a cutin synthase gene;
C. fermenting the bacterial culture from step (b) to allow for production of genetically modified cutin;
D. isolating the genetically modified cutin.

99. The method of claim 98, wherein the recombinant cutin comprises cutin expressed from a DNA of a bacteria.

100. The method of claim 98, wherein the recombinant bacterium comprises a recombinant cutin synthase gene.

101. The method of claim 98, wherein the bacteria is selected from a group consisting of Bacillus subtilis, Pseudomonas putida, Streptomyces, Corynebacterium glutamicum, Agrobacterium tumefaciens, and combination thereof.

102. The method of claim 98, wherein the edible composition further comprises a pH stabilizer, at least one metal ion, an essential oil, an emulsifying agent, or combinations thereof.

103. The method of claim 102, wherein the pH stabilizer comprises a proton acceptor.

104. The method of claim 103, wherein the proton acceptor comprises an inorganic proton acceptor.

105. The method of claim 102, wherein the at least one metal ion is a food safe metal ion.

106. The method of claim 105, wherein the at least one metal ion is a water-soluble metal salt.

107. The method of claim 106, wherein the at least one metal ion comprises a silver salt, a copper salt, a zinc salt, a gold salt, a cobalt salt, a zirconium salt, a molybdenum salt, a palladium salt, or a combination thereof.

108. The method of claim 88, wherein the essential oil is selected from a group consisting of tea tree oil, thyme oil, eucalyptus oil, oregano oil, peppermint oil, rosemary oil, clove oil, cinnamon oil, lemongrass oil, and a combination thereof.

109. The method of claim 88, wherein the emulsifying agent comprises lecithin, a monoglyceride, a diglyceride, a polysorbate, a carrageenan, a polyglycerol of a fatty acid, a sorbitol ester, a beeswax, or combinations thereof.

110. The method of claim 102, wherein the emulsifying agent comprises polysorbate 80, sodium stearoyl lactylate, propylene glycol, tween 80, and sodium caseinate.

111. The method of claim 98, wherein the genetically modified cutin preserves the food product for at least 14 days.

112. The method of claim 102, wherein the temperature of step (a) ranges from about 30° C. to about 50° C.

113. The method of claim 102, wherein the temperature of step (b) ranges from about 30° C. to about 60° C.

114. The method of claim 102, wherein the temperature of step (c) ranges from about 30° C. to about 50° C.

115. The method of claim 102, wherein the genetically modified cutin has a yield of at least 50%.

116. The method of claim 102, wherein the genetically modified cutin has a purity of at least 50%.

117. The method of claim 102, wherein the edible composition has a pH from 6.0 to 8.0.

118. The method of claim 102, wherein the edible composition is light stable, non-toxic, and non-corrosive.

119. A method for preserving a food product comprising contacting the food product with the edible composition of claim 79.

120. The method of claim 119, wherein the food product is a fruit or a vegetable.

121. The method of claim 119, wherein the method preserves and maintains the freshness of the food product for at least 14 days.

122. The method of claim 119, wherein the food product maintains a hydration level within the food product.
